(19) United States
(12) Patent Application Publication
(10) Pub. No.: US 2026/0234478 A1
(43) Pub. Date: Aug. 13, 2026

(54) METHOD FOR CONTROLLING A HEAT-CONSUMING HYDROCARBON CONVERSION PROCESS

(71) Applicant: BASF SE, Ludwigshafen am Rhein (DE)

(72) Inventors: Daniel KECK, Ludwigshafen am Rhein (DE); Rombout KELDERMANS, Antwerpen (BE); Pieter REYNIERS, Ludwigshafen am Rhein (DE); David VAN CAUWENBERGE, Antwerpen (BE); Joerg UNGER, Ludwigshafen am Rhein (DE); Stefan DAHMEN, Ludwigshafen am Rhein (DE)

(21) Appl. No.: 19/151,802

(22) PCT Filed: Jan. 30, 2024
(86) PCT No.: PCT/EP2024/052230

§ 371 Date: Jul. 29, 2025

(30) Foreign Application Priority Data
Jan. 31, 2023 (EP) 23154159.0

(51) Int. Cl. C10G 9/36; C01B 3/382

(52) U.S. Cl. CPC C10G 9/36; C01B 3/382; C01B 2203/0216; C01B 2203/0244; C01B 2203/0283; C01B 2203/0475; C01B 2203/062; C10G 2300/42

(57) ABSTRACT

The present invention relates to a method for controlling a process carried out in an integrated production plant, wherein the process comprises subjecting at least one hydrocarbon feed stream to hydrocarbon conversion in a heat-consuming hydrocarbon conversion unit, and wherein the process is controlled so that heat which cannot be supplied to the heat-consuming hydrocarbon conversion unit via one or more plant-external sustainable heat sources is preferably supplied by hydrogen which is obtained from a light hydrocarbon conversion off-gas stream obtained from the heat-consuming hydrocarbon conversion unit.

The present invention relates to a method for controlling a process carried out in an integrated production plant and further relates to said process as such, wherein said process comprises subjecting at least one hydrocarbon feed stream to hydrocarbon conversion in a heat-consuming hydrocarbon conversion unit. Further, the present invention relates to an integrated production plant in which said process and said method are carried out.

Usually, many basic hydrocarbon conversion processes are endothermic processes which require heat for being carried out. Examples therefor are processes carried out in plants which comprise crackers such as steam crackers, ammonia plants, or steam reformers. If such processes are carried out along the lines of a responsible ecologically-driven process management, the necessary heat will be provided making use of one or more plant-external sustainable heat sources such as solar energy, wind energy, hydro energy, tidal energy, geothermal energy, and biomass energy, ammonia obtained from renewable sources, biomethane, bio-LNG and H₂ obtained from renewable sources. However, the availability of such plant-external sustainable heat sources may vary over time, and for certain periods of time, the respective amount of heat may not be sufficient to meet the needs of the process. Certainly, for such cases, it may be generally conceivable to use, in addition to the plant-external sustainable heat sources, other plant-external non-sustainable heat sources, i.e. fossil heat sources such as coal, oil or coal. However, according to the above-mentioned ecologically-driven process management, this is not an entirely preferred procedure. Alternatively, according to said scenario, the hydrocarbon conversion process could be shut down and started up once the necessary amount of heat via the plant-external sustainable heat sources is sufficiently high again; it is needless to say that this alternative is not desirable per se from an economical point of view.

U.S. Pat. No. 11,498,834 B1 discloses a process for producing H₂-rich fuel gas from hydrocarbons such as natural gas, and the use thereof in heating such as industrial heating in an olefin production plant. A hydrocarbon feedstock is supplied to a heat consuming hydrocarbon conversion, such as a steam cracker, to obtain product streams which, after separation, inter alia lead to a light hydrocarbon conversion off-gas stream comprising CH₄. This light hydrocarbon conversion off-gas stream is reformed to obtain a product gas stream comprising CO and H₂. The product gas stream may be further processed in a controllable processing unit to obtain a stream enriched in H₂.

EP 3 249 028 A1 relates to a low-emission process for the production of olefins by steam cracking, wherein a gas mixture is provided by using a plurality of tubular reactors, each of which using the multiple tubular reactors are combined.

Therefore, it was an object of the present invention to provide a method for controlling a process which is carried out in an integrated production plant and which comprises subjecting at least one hydrocarbon feed stream to hydrocarbon conversion in a heat-consuming hydrocarbon conversion unit in such a way that in case the heat supply to said hydrocarbon conversion cannot be provided by plant-external sustainable heat sources, the least possible amount of plant-external fossil heat sources needs to be used.

Thus, the present invention relates to a method for controlling a process carried out in an integrated production plant, wherein the integrated production plant comprises
(1) supply means M_{F} for providing one or more hydrocarbon feed streams S_{F} to a unit U_{C} for heat-consuming hydrocarbon conversion to obtain from U_{C} one or more product streams S and a light hydrocarbon conversion off-gas stream S_{O} comprising CH₄;
(2) the unit U_{C} which comprises heating means M_{H} for providing heat to the hydrocarbon conversion, wherein said heating means M_{H} comprise means for generating heat from one or more heat sources H_{S} and wherein said one or more heat sources H_{S} comprise H₂;
(3) controllable supply means M_{E} for providing one or more plant-external sustainable heat sources H_{EXT-S}, one or more plant-external fossil heat sources H_{EXT-F}, and one or more plant-internal heat sources H_{INT}, said plant-internal heat sources H_{INT} comprising H₂, for passing at least one of said heat sources H_{EXT-S}, H_{EXT-F} and H_{INT} to the heating means M_{H};
(4) a reforming unit U_{R} for subjecting the light hydrocarbon conversion off-gas stream S_{O} to reforming to obtain a product gas stream S_{R} comprising CO and H₂;
(5) a controllable processing unit U_{P} for processing S_{R} or a part stream S′_{R} thereof to obtain a stream S_{H} being enriched in H₂ compared to S_{R} or S′_{R};
(6) and optionally comprises controllable supply means M_{R} for optionally dividing the stream S_{R} into the part stream S′_{R} and a stream S″_{R}, and for passing S′_{R} into U_{P};
   wherein the process comprises
(i) passing one or more heat sources according to (3) from M_{E} to M_{H} in an amount sufficient for generating heat in My meeting the heat demand E_{UC} of the hydrocarbon conversion in U_{C};
(ii) passing at least one hydrocarbon feed stream S_{F} into U_{C} and subjecting the at least one feed stream S_{F} to hydrocarbon conversion in U_{C}, obtaining the one or more product streams S and S_{O};
(iii) passing S_{O} into U_{R} and subjecting S_{O} to reforming in U_{R}, obtaining S_{R};
   wherein the method for controlling the process comprises
(a) determining the heat demand E_{UC} of the hydrocarbon conversion in U_{C} to be provided by M_{H};
(b) determining the amount E_{EXT-S} of heat available for U_{C} from the one or more plant-external sustainable heat sources H_{EXT-S};
(c) determining ΔE=E_{UC}−E_{EXT-S} and
   (c.1) if ΔE>0,
      (c.1.1) determining H_{2N}, the amount of H₂ necessary to produce ΔE in M_{H};
      (c.1.2) determining H_{2P}, the maximum amount of H₂, producible in U_{R} and U_{P} to be contained in S_{H}, to produce an amount E_{H2P} of heat in M_{H};
      (c. 1.3) determining ΔH=H_{2N}−H_{2P}; and
         (c.1.3.1) if ΔH>0,
         controlling the processing unit U_{P}, the supply means M_{E} and optionally the supply means M_{R} so that H_{2P} is passed into M_{H} via S_{H};
         wherein the process further comprises
         (iv) optionally passing S_{R} obtained from U_{R} through M_{R}, obtaining a stream S′_{R} being x volume-% of S_{R}, with x=100;
         (v) passing the stream S_{R} or, if (iv) is carried out, the stream S′_{R} into U_{P}, obtaining S_{H};
         (vi) passing the stream S_{H} obtained from U_{P} through M_{E}, obtaining a stream S′H being y volume-% of S_{H}, with y=100;
         (vii) passing the stream S′H obtained from M_{E} as H_{INT} into M_{H};
         (viii) passing at least one of the one or more plant-external fossil heat sources H_{EXT-F} via M_{E} into My in an amount sufficient to generate heat in an amount (ΔE−E_{H2P}) in M_{H};
         (c. 1.3.2) if ΔH≥0,
         controlling the processing unit U_{P}, the supply means M_{E} and
         optionally the supply means M_{R} so that an amount of H₂ is passed into My via S_{H} which is sufficient to produce ΔE in M_{H};
         wherein the process further comprises
         (iv′) optionally passing S_{R} obtained from U_{R} through M_{R}, obtaining a stream S′_{R} being x volume-% of S_{R}, with 0<x≤100;
         (v′) passing the stream S_{R} or, if (iv) is carried out, the stream S′_{R} into U_{P}, obtaining S_{H};
         (vi′) passing the stream S_{H} obtained from U_{P} through M_{E}, obtaining a stream S′_{H} being y volume-% of S_{H}, with 0<y≤100;
         (vii′) passing the stream S′_{H} obtained from M_{E} as H_{INT} into M_{H};
   (c.2) if ΔE≤0,
      controlling the processing unit U_{P}, the supply means M_{E} and optionally the supply means M_{R} so that no H₂ is passed into M_{H} via S_{H};
      wherein the process further comprises
         (iv″) optionally passing S_{R} obtained from U_{R} through M_{R}, obtaining a stream S′_{R} being x volume-% of S_{R}, with 0≤x≤100;
         (v″) passing the stream S_{R} or, if (iv′) is carried out and x≠0, the stream S′_{R} into U_{P}, obtaining S_{H};
         (vi″) passing the stream S_{H}, if obtained from U_{P}, through M_{E}, obtaining a stream S″_{H} being 100 volume-% of S_{H};
         (vii″) removing the stream S″_{H} from M_{E}.

### Unit U_{C}

Generally, there are no specific restrictions which unit U_{C} for heat-consuming hydrocarbon conversion according to (1) is part of the plant with the proviso that from U_{C}, one or more product streams S and a light hydrocarbon conversion off-gas stream S_{O} comprising CH₄ are obtained. Preferably, the unit U_{C} for heat-consuming hydrocarbon conversion comprises a cracking unit U_{CC}.

Cracking is a petrochemical process wherein saturated hydrocarbons having long molecular structures are broken down, i.e. cracked, into smaller saturated or unsaturated molecules.

Generally, crackers aim at producing light alkenes as valuable products, especially ethylene and propylene. Cracking processes include fluid catalytic cracking (FCC) and steam cracking.

Conventional steam cracking utilizes a pyrolysis furnace which has two main sections: a convection section and a radiant section. The hydrocarbon feedstock typically enters the convection section of the furnace as a liquid, or, in a case where light feedstocks are used, as a vapor, wherein it is typically heated and, if necessary, vaporized by indirect contact with hot off-gas from the radiant section and by direct contact with steam. The vaporized feedstock and steam mixture is then introduced into the radiant section where the cracking takes place. The resulting stream having a temperature typically in the range of from 500 to 650° C. enters a fired tubular reactor and is heated to a temperature typically in the range of from 750 to 875° C. for 0.1 to 0.5 s, wherein the residence time, temperature profile and partial pressure is controlled. During this short reaction time, hydrocarbons in the feedstock are cracked into smaller molecules yielding light olefins such as ethylene, propylene, butylenes, other small olefins, and diolefins as major products besides methane. These reaction products suitably typically leave the radiant tube at a temperature in the range of 800 to 850° C. and are preferably cooled to a temperature typically in the range of from 550 to 650° C. within 0.02 to 0.1 s in order to prevent degradation of the highly reactive compounds by secondary reactions. Then, the resulting stream leaves the furnace for further downstream processing.

In fluid catalytic cracking (FCC), a particulate catalyst, often having a particle size in the range of from 20 to 100 μm, circulates between a cracking reactor and a catalyst regenerator. In the reactor, a hydrocarbon feed contacts the hot, regenerated catalyst. The hot catalyst vaporizes and cracks the feed typically at 425 to 600° C. The cracking reaction deposits carbonaceous hydrocarbons, which eventually turn to coke on the catalyst, thereby deactivating it. The cracked products are separated from the coked catalyst, usually with the aid of a catalyst stripper, and the stripped catalyst is then regenerated within the regenerator. A catalyst regenerator burns coke from the catalyst with oxygen containing gas, usually air. Regeneration of the catalyst by oxidation restores catalyst activity and simultaneously typically heats the catalyst to 500 to 900° C. The heated catalyst is recycled to the cracking reactor to crack more fresh hydrocarbon feed.

According to the present invention, the cracking unit U_{CC} is preferably a thermal cracking unit, more preferably a steam cracking unit.

### Feed Streams S_{F}

The one or more hydrocarbon feed streams S_{F} of which at least one is passed into U_{C} and subjecting therein to hydrocarbon conversion according to (ii) may, for example, originate from upstream refinery processes such as an atmospheric distillation tower, a hydrocracker, a coker or the like and typically contains naphtha, liquefied petroleum gas (LPG), ethane, propane and/or butane. Alternatively or additionally, the one or more hydrocarbon feed streams S_{F} comprise at least one of a hydrocarbon feed stream comprising, preferably consisting of, fossil hydrocarbons; a hydrocarbon feed stream comprising, preferably consisting of, recycled hydrocarbons; and a hydrocarbon feed stream comprising, preferably consisting of, biohydrocarbons.

The term “fossil hydrocarbons” as used herein encompasses, for example, natural gas such as a naturally occurring mixture of gaseous hydrocarbons which primarily consists of methane in addition to small amounts of other higher alkanes such as ethane, propane and the like. Further, the term “fossil hydrocarbons” as used herein encompasses naphtha such as liquid hydrocarbon mixtures produced from natural gas condensates, petroleum distillates, and the distillation of coal tar and peat. Yet further, the term “fossil hydrocarbons” as used herein encompasses liquefied petroleum gas (LPG) such as a fuel gas containing a flammable mixture of hydrocarbon gases, in particular propane and butane, prepared by refining petroleum or “wet” natural gas.

The term “recycled hydrocarbons” as used herein encompasses, for example, pyrolysis oils obtained by pyrolysis of recycled plastic waste materials.

The term “biohydrocarbons” as used herein encompasses, for example, bio-based gases such as mixtures of gases primarily consisting of methane besides carbon dioxide and hydrogen sulfide which are produced from raw materials such as agricultural waste, manure, municipal waste, plant material, sewage, green waste, food waste and the like. Further, the term “biohydrocarbons” as used herein encompasses bio-naphtha such as naphtha produced from complex mixtures of naturally occurring fats and oils. Yet further, the term “biohydrocarbons” as used herein encompasses bio-liquefied petroleum gas (bio-LPG) such as liquefied petroleum gas produced from complex mixtures of naturally occurring fats and oils.

According to the present invention, the one or more hydrocarbon feed streams S_{F} preferably comprise at least one of a hydrocarbon feed stream comprising, preferably consisting of, fossil hydrocarbons; a hydrocarbon feed stream comprising, preferably consisting of, recycled hydrocarbons; and a hydrocarbon feed stream comprising, preferably consisting of, biohydrocarbons. Thus, also mixtures of two or more of the aforementioned are included.

Further according to the present invention, the unit U_{C} comprises heating means M_{H} for providing heat to the hydrocarbon conversion. Said heating means M_{H} comprise means for generating heat from one or more heat sources H_{S}, either from one or more plant-external sustainable heat sources H_{EXT-S}, and/or one or more plant-external fossil heat sources H_{EXT-F}, and/or one or more plant-internal heat sources H_{INT}. Further, the at least one heat source H_{S} comprises hydrogen (H₂) which is either comprised in H_{EXT-S}, and/or in H_{EXT-F} and/or in H_{INT}. Thus, the heating means M_{H} comprised in U_{C} comprise at least means for combusting H₂ and providing the resulting heat to the hydrocarbon conversion.

### Heat Demand of U_{C}

According to (i), one or more heat sources according to (3) are passed from M_{E} to M_{H} in an amount sufficient for generating heat in M_{H} meeting the heat demand E_{UC} of the hydrocarbon conversion in U_{C}.

According to the present invention, the heat demand E_{UC} of the hydrocarbon conversion process carried out in the unit U_{C} of the integrated plant is generally supplied via the one or more plant-external sustainable heat sources H_{EXT-S}. In case, however, the heat demand E_{UC} cannot be supplied by H_{EXT-S} alone, additional heat is required which, according to the present invention, is provided at least partially via the heat source H₂ comprised in the stream S_{H} obtained from the processing unit U_{P}. In addition to H₂ comprised in the stream S_{H}, also one or more other plant-internal heat sources H_{INT} may be used for supplying heat to U_{C} via the controllable means M_{E}, for example other sources of plant-internally product hydrogen and/or other plant-internally produced fuels and/or electrical heat which may be used. Preferably according to the present invention, the heat source H₂ comprised in the stream S_{H} is the sole plant-internal heat source H_{INT} which is used instead of or in addition to H_{EXT} for meeting the heat demand E_{UC} of U_{C}. If, and only if, the heat demand E_{UC} of U_{C} cannot be met by H_{EXT-S} in combination with H_{INT}, the remaining energy demand would be provided by one or more plant-external fossil heat sources H_{EXT-F}.

For combustion of hydrogen in M_{H}, the stream S′_{H}, based on the stream S_{H} and provided via the means M_{E} is preferably mixed with oxygen and combusted in burners or heating coils comprised in U_{C}.

Generally, there are no specific restrictions which sustainable heat source H_{EXT-S} is employed. Preferably, according to the present invention, the one or more plant-external sustainable heat sources H_{EXT-S} according to (3) comprise one or more of solar energy, wind energy, hydro energy, tidal energy, geothermal energy, biomass energy, ammonia obtained from renewable sources, biomethane, bio-LNG and H₂ obtained plant-externally from renewable sources. Depending on their respective physical nature, the plant-external sustainable heat sources H_{EXT-S} are, for example, used to provide heat via direct electrical heating or via combustion, as for example in the case of hydrogen wherein thermal energy is provided to the heat-consuming hydrocarbon conversion process. Generally, combusting hydrogen yields water as the only by-product. Thus, advantageously, in particular if hydrogen is employed as plant-external sustainable heat source H_{EXT-S}, the process of the present invention allows for an emission-reduced operation of the hydrocarbon conversion process, preferably the cracking process. As used herein, the term “emission-reduced operation” relates to a process which is carried out in such a way that the emission of greenhouse gases such as carbon dioxide is avoided or at least reduced, i.e. at a reduced carbon footprint.

### Processing of the Cracked Gas

In particular in the case when the unit U_{C} comprises a cracking unit U_{CC}, the gas stream obtained directly from the hydrocarbon conversion, i.e. the cracking process, said stream being referred to herein as the cracked gas stream S_{C}, is subjected to a one or more downstream process stages from which, among others the one or more product stream S and the light hydrocarbon conversion off-gas stream S_{O} are obtained.

Generally, the stream S_{C} which comprises light olefins such as ethylene, propylene, butylenes, other lower olefins and diolefins besides methane is separated into several different streams by using a sequence of separation and chemical-treatment stages. In the hydrocarbon conversion process, also light side products such as hydrogen, carbon oxides, light saturated hydrocarbons, and water are typically obtained. Suitably, the one or more product streams S, especially ethylene and propylene, are either used directly in downstream processes, optionally or preferably part of the integrated plant, or stored in storage vessels for subsequent use or long-term storage, either plant-internally or plant-externally.

The recovery of the various olefin products, i.e. the product streams, from cracked gas is usually carried out by fractional distillation using a series of distillation steps to separate out the various components. The unit which separates hydrocarbons with one carbon atom (C₁) and lighter fraction is generally referred to as “demethanizer”. The unit which separates hydrocarbons with two carbon atoms (C₂) from the heavier components is referred to as “deethanizer”. The unit which separates the hydrocarbon fraction with three carbon atoms (C₃) from the heavier components is referred to as “depropanizer”. The unit which separates the hydrocarbon fraction with four carbon atoms (C₄) from the heavier components is referred to as “debutanizer.”

The residual heavier components having a higher carbon number fraction (C₅₊) may be used as gasoline or be recycled back to the cracker. Alternatively, they may be sent to a suitable hydrocarbon-to-hydrogen conversion process.

The various fractionation units may be arranged in a variety of sequences in order to provide desired results based upon various feedstocks. To that end, a sequence which uses the demethanizer first is commonly referred to as the “front-end demethanizer” sequence. Similarly, when the deethanizer is used first, it is commonly referred to as the “front-end deethanizer” sequence. And, when the depropanizer is used first, it is commonly referred to as “front-end depropanizer” sequence.

In the conventional front-end demethanizer sequence, the cracked gas containing hydrocarbons having one to five or more carbon atoms per molecule (C₁ to C₅₊) first enters a demethanizer, where methane and lighter fractions (hydrogen) are separated as an over-head stream. The demethanizer usually operates at relatively low temperatures, typically in the range of from −100° C. to about 25° C.

The front-end demethanizer over-head stream constitutes a generally suitable light hydrocarbon off-gas stream to be passed to the reforming unit U_{R} according to (iii). Alternatively, hydrogen contained in the front-end demethanizer over-head stream may be removed first and the remaining gas consisting mainly of methane is passed as the stream S_{O} to the reforming unit U_{R} according to (iii).

The heavy ends leaving the demethanizer consist mainly of C₂ to C₅₊ molecules. These heavy ends then are preferably passed to a deethanizer where the C₂ hydrocarbons are removed at the top and the C₃ to C₅₊ compounds leave the deethanizer as bottoms. The C₂ components leaving the top of the deethanizer may be fed to an acetylene converter or acetylene removal unit. As some methane remains dissolved in the heavy ends exiting the demethanizer and ends up in the C₂ components leaving the deethanizer, the C₂ components stream may be subsequently sent to a demethanizer for removal of the remaining methane. This residual demethanizer overhead stream then would constitutes a suitable light hydrocarbon off-gas stream S_{O} to be passed to the reforming unit U_{R} according to (iii).

Therefore, the unit U_{C} preferably further comprises a separation unit US, wherein according to
(ii), the process comprises
(ii.1) passing at least one hydrocarbon feed stream S_{F} into U_{C} and subjecting the at least one feed stream S_{F} to hydrocarbon conversion in U_{C}, obtaining a cracked gas stream S_{C};
(ii.2) passing the cracked gas stream S_{C} obtained according to (ii.1) to a separation unit Us comprising at least one demethanizing unit, obtaining from said demethanizing unit the stream S_{O}, wherein from U_{S}, the one or more product streams S are obtained.

As described above, the separation unit U_{S} preferably comprises a distillation tower from which an overhead stream is obtained which comprises methane and hydrogen. The overhead stream comprises methane and hydrogen as the main components. The ratio of methane and hydrogen in the overhead stream may vary depending on the cracking operation conditions, and the hydrocarbon feed streams S_{F}, respectively. Reference can be made, for example, to Ullmann's Encyclopedia of Industrial Chemistry, Ethylene 5.1.3 Commercial Cracking Yields, DOI: 10.1002/14356007.a10_045.pub3 for different cracking yields depending on different cracker feedstocks. Generally, the methane concentration in the overhead is in the range of from 40 to 95 weight-%, preferably in the range of from 90 to 95 weight-% of methane, with the remainder being mainly hydrogen.

Still further preferred is a separation unit which, in addition to and downstream of said distillation tower, comprises a gas separation unit from which, based on said overhead stream comprising methane and hydrogen, a methane-rich stream and a hydrogen-rich stream are obtained. Separating the overhead stream and subjecting only the methane-rich stream as the stream S_{O} stream to U_{R} leads to a higher overall hydrogen yield compared to subjecting the overhead stream directly as the stream S_{O} to U_{R} since the reforming process carried out in U_{R} is based on equilibrium reactions and it may be detrimental to the overall yield of hydrogen if the stream S_{O} passed to U_{R} comprises significant amounts of hydrogen.

Therefore, the demethanizing step according to (ii.2) preferably comprises a distillation step from which an overhead stream S_{O1} is obtained comprising CH₄ and H₂, and further preferably, the demethanizing step according to (ii.2) comprises a separation step wherein Son is separated into a H₂-rich stream and a CH₄-rich stream S_{O2}, wherein S_{O1} or a partial stream thereof, preferably S_{O2} or a partial stream thereof, is subjected as the stream S_{O} into U_{R} according to (iii).

As far as the separation step wherein Soi is separated into a H₂-rich stream and a CH₄-rich stream S_{O2} is concerned, no particular limitations exist regarding the suitable unit in which this separation is carried out. As an example, said separation can be carried out using a pressure swing adsorption unit. Preferably, said H₂-rich stream exhibits a H₂ content in the range of from 90 to 100 volume-%, more preferably in the range of from 95 to 100 volume-%. Optionally, according to the present invention, said H₂-rich stream can be suitably combined with the stream S′_{H} in which case according to (c. 1.1), the determination of the amount H_{2P} of H₂ and controlling the processing unit U_{P}, the supply means M_{E} and optionally the supply means M_{R} according to (c.1.3) would take into account the H₂ content of said H₂-rich stream.

As far as the composition of the stream S_{O} to be passed to U_{R} is concerned, it is preferred that from 96 to 100 volume-% of S_{O} consist of CH₄. More preferably from 97 to 100 volume-%, more preferably from 98 to 100 volume-%, more preferably from 99 to 100 volume-%, more preferably from 99.5 to 100 volume-%, more preferably from 99.9 to 100 volume-% of S_{O} consists of CH₄. Further preferably, from 0 to 4 volume-% of S_{O} consist of H₂. More preferably from 0 to 3 volume-%, more preferably from 0 to 2 volume-%, more preferably from 0 to 1 volume-%, more preferably from 0 to 0.5 volume-%, more preferably from 0 to 0.1 volume-% of S_{O} consist of H₂.

The C₂ components from which methane has been removed are then preferably sent to a C₂ splitter which produces ethylene as the light product and ethane as the heavy product. The C₃ to C₅₊ stream leaving the bottom of the deethanizer is preferably routed to a depropanizer from which the C₃ components are obtained overhead and the C₄ to C₅₊ components are obtained as the bottoms. The C₃ product may be hydrotreated to remove C₃ acetylene and dienes before being fed to a C₃ splitter where it is separated into propylene at the top and propane at the bottom. The C₄ to C₅₊ stream is preferably fed to a debutanizer from which C₄ components are obtained at the top with the balance of C₅₊ components being obtained as the bottoms. Both the C₄ and the C₅₊ streams may be separately hydrotreated to remove undesirable acetylenes and dienes.

In conventional front-end deethanizer sequences, the cracked gas S_{C} containing C₁ to C₅₊ components first enters a deethanizer. The light ends exiting the deethanizer consist of C₂ and C₁ components along with any hydrogen. These light ends are usually fed to a demethanizer where the hydrogen and C₁ are removed as light components and the C₂ components are removed as the heavy components. The C₂ stream leaving the bottom of the demethanizer may be fed to an acetylene converter and then to a C₂ splitter which produces ethylene as the light product and ethane as the heavy product. The heavies leaving the deethanizer which consist of C₃ to C₅₊ components are usually routed to a depropanizer from which the C₃ components are obtained overhead and the C₄ to C₅₊ are obtained as the bottoms. The C₃ product is the usually fed to a C₃ splitter where it is separated into propylene at the top and propane at the bottom, while the C₄ to C₅₊ stream is fed to a debutanizer which produces C₄ compounds at the top with the balance leaving as bottoms to be used for gasoline or to be recirculated as feed into the cracking process. As with the front-end demethanizer sequence, the C₃, C₄, and C₅₊ streams may be separately hydrotreated to remove undesirable acetylenes and dienes.

In conventional front-end depropanizer sequences, the quenched and acid-free gases containing hydrocarbons having from one to five or more carbon atoms per molecule (C₁ to C₅₊) first enter a depropanizer. The heavies leaving the depropanizer consist of C₄ to C₅₊ components. These are usually passed to a debutanizer where the C₄ components and lighter species are taken over the top with the rest of the feed leaving as bottoms which can be used for gasoline or other chemical recovery. These streams may be separately hydrotreated to remove undesired acetylenes and dienes. The lights of the depropanizer containing C₁ to C₃ components may be fed to an acetylene converter and then to a demethanizer system where the C₁ components and any remaining hydrogen are generally removed overhead. The heavies leaving the demethanizer system containing C₂ and C₃ components are usually passed into a deethanizer wherein C₂ components are removed from the top and C₃ compounds are obtained as the bottoms. The C₂ components are, in turn, usually fed to a C₂ splitter which produces ethylene as the light product and ethane as the heavy product. The C₃ stream is fed to a C₃ splitter which separates the C₃ species, sending propylene to the top and propane to the bottom.

As with the front-end demethanizer sequence, the saturated C₂ hydrocarbons and/or the saturated C₃ hydrocarbons obtained in the front-end deethanizer sequence or the front-end depropanizer sequence or a partial stream thereof may be recycled as feed into the cracking process.

### The Reforming Unit U_{R}

According to the present invention, the light hydrocarbon off-gas stream S_{O} is passed according to (iii) into the reforming unit U_{R} according to (4) where it is subjected to reforming and wherein from said reforming, the product gas stream S_{R} is obtained.

Preferably, the reforming unit U_{R} comprises one or more of an autothermal reforming (ATR) unit, a steam reforming (STR) unit, and a partial oxidation (POX) unit, preferably one or more of an autothermal reforming (ATR) unit and a steam reforming (STR) unit.

Steam reforming is a catalytic reaction suitable to convert hydrocarbons in the presence of steam to synthesis gas containing hydrogen and carbon monoxide. The reaction is typically carried out in a multitubular reactor commonly packed with a catalyst. Most commercial catalysts are nickel-based and make use of carriers such as alumina and/or zirconia. Generally, it is desirable that the feedstock does not contain sulfur compounds as these compounds are strong poisons to the catalysts used in steam reforming. Regarding catalysts, process parameters as well as reaction setups including reactor types, reference can be made, for example, to Ullmann's Encyclopedia of Industrial Chemistry, Hydrogen, 2. Production, 1.3 Catalytic reforming of Hydrocarbons, DOI: 10.1002/14356007.o13_o03; or Ullmann's Encyclopedia of Industrial Chemistry, Gas Production, 2. Processes, 1. Steam Reforming of Natural Gas and other Hydrocarbons, DOI: 10.1002/14356007.o12_o01). For methane as the main component in the stream S_{O}, steam reforming proceeds according to the following main reaction:

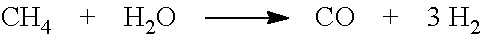

The reaction is endothermic and requires high temperatures typically above 800° C. in the reactor outlet. The methane reforming process is preferably carried out in tubes filled with catalyst inside a fired furnace. Suitably, steam is used in excess of the reaction stoichiometry requirements in order to prevent the catalyst from coking.

Partial oxidation is a non-catalytic process wherein a sub-stoichiometric amount of oxygen is allowed to react with a carbonaceous material like natural gas, liquid feeds such as fuel oils, gas oils, and/or coal at high temperatures to give synthesis gas containing hydrogen and carbon monoxide. Regarding process parameters as well as reaction setups including reactor types, reference is made, for example, to Ullmann's Encyclopedia of Industrial Chemistry, Hydrogen, 2. Production, 1.2 Gasification of Coal and Hydrocarbons, DOI: 10.1002/14356007.o13_o03; or Ullmann's Encyclopedia of Industrial Chemistry, Gas Production, 2. Processes, 2. Noncatalytic Partial Oxidation and Special Gasification Processes for Higher-Boiling Hydrocarbons, DOI: 10.1002/14356007.o12_o01. For methane as the main component in the stream S_{O}, partial oxidation proceeds according to the following main reactions:

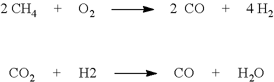

For these partial oxidation reactions, the stream S_{O} is preferably mixed with air, oxygen-enriched air, and/or molecular oxygen and introduced into a partial oxidation reactor at an elevated temperature of generally at least 1200° C. and reacted thermally without a catalyst. Typically, the temperature of the synthesis gas leaving the partial oxidation reactor is in the range of from 1200 to 1300° C., or higher. In principle, the partial oxidation reaction can be carried out without any steam addition.

Auto thermal reforming is a variant of the partial oxidation process as described above, using oxygen and steam, and optionally also carbon dioxide, in a reaction with methane comprised in S_{O} to form synthesis gas containing hydrogen and carbon monoxide. Should the stream S_{O} comprise any hydrocarbons higher than methane, pre-reforming can be carried out. This avoids the potential problems of olefin formation from higher hydrocarbons in the ATR and reduces the possibility of coke formation on the main reformer catalyst. In the pre-reformer, typically a steam reformer, all higher hydrocarbons (C₂₊) are converted into a mixture of methane, hydrogen, carbon monoxide and carbon dioxide according to the following reactions:

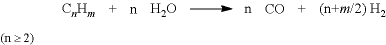

Generally, for methane, the abovementioned reactions also occur in auto thermal reforming, together with the following reaction

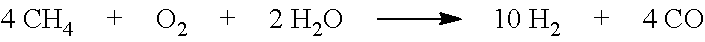

In auto thermal reforming, a catalyst is preferably used to permit reforming to occur at lower temperatures than the partial oxidation process. Moderate amounts of steam are typically used to prevent the catalyst from coking. Regarding catalysts, process parameters as well as reaction setups including reactor types, reference can be made, for example, to Ullmann's Encyclopedia of Industrial Chemistry, Hydrogen, 2. Production, 1.3 Catalytic reforming of Hydrocarbons, DOI: 10.1002/14356007.o13_o03; or Ullmann's Encyclopedia of Industrial Chemistry, Gas Production, 2. Processes, 1. Steam Reforming of Natural Gas and other Hydrocarbons, 1.5. Autothermal Catalytic Reforming, DOI: 10.1002/14356007.o12_o01. Generally, for carrying out an auto thermal reforming process, the feed stream S_{O} is vaporized and water is provided in the form of steam. For this purpose, the feed stream S_{O} and water may be subjected to a vaporization process in a vaporizer. Typically, the vaporizer is heated by hot combustion gases provided form a combustor, enabling the vaporizer to vaporize the feed stream S_{O} and water channeled therethrough. Then, the vaporized feed stream, steam and air are mixed using a mixing unit and the resulting mixture is introduced into an auto thermal reformer. Preferably, the main elements of the auto thermal reformer are a burner, a combustion chamber, and a catalyst bed contained within a refractory lined pressure shell. The catalyst is typically nickel-based. In the auto thermal reformer, partial combustion of the hydrocarbon feed stream by sub-stoichiometric amounts of oxygen is followed by reaction of the partially combusted feedstock with steam in a fixed bed of steam reforming catalyst. Reaction of methane with steam according to also takes place to some extent in the combustion chamber due to the high temperature. The steam reforming reaction may be accompanied by water gas shift reactions. Typically, the synthesis gas leaves the auto thermal reformer having an outlet temperature in the range of from 850 to 1100° C. and an outlet pressure of up to 100 bar.

Preferably, the product gas stream S_{R} obtained from the reforming unit U_{R} exhibits a molar ratio CO:H₂ in the range of 1:2 to 1:3.

Optionally, downstream of the reforming unit and upstream of the processing unit U_{P}, controllable supply means M_{R} according to (6) are arranged. Preferably, the supply means M_{R} are used for dividing the product gas stream obtained from the reforming unit U_{R} into two or more gas streams, preferably a gas stream S′_{R} and stream S″_{R} which have the same chemical composition as the product gas stream obtained from the reforming unit U_{R}. One of these streams, S′_{R}, is then passed into the downstream processing unit U_{P}. Suitable supply means M_{R} include, for example, a controllable valve.

### Processing Unit U_{P}

According to the present invention, the stream S_{R} or a part stream S′_{R} thereof is suitably processed in the controllable processing unit U_{P} from which the stream S_{H} is obtained which is enriched in H₂ compared to S_{R} or S′_{R}.

Generally, there are no specific restrictions regarding the specific setup of the processing unit U_{P}, with the proviso that a suitable gas stream S_{H} can be obtained. Preferably, the processing unit U_{P} according to (5) comprises one or more of a gas separation unit U_{PG} and a water gas shift reaction unit U_{PW}.

### U_{P} Comprising a Gas Separation Unit

According to a first embodiment of the present invention, the processing unit U_{P} comprises a gas separation unit U_{PG} into which the stream S_{R} or the stream S′_{R} are passed and from which a stream S_{H} and a CO-rich stream S_{CO} are obtained. For such gas separation of the stream S_{R} or the stream S′_{R}, high boiling impurities such as water, carbon dioxide and/or optionally, if present, C₂₊ alkanes are preferably removed first. Separation of C₂₊ alkanes can be achieved by condensation or distillation processes. Separation of water can be achieved by scrubbing, e.g. with glycol. Separation of CO₂ can be achieved by gas washing, for examples by acid gas removal. Mixtures comprising hydrogen, carbon dioxide and methane can be separated, for example, by cryogenic processes, pressure swing absorption and/or methane scrubbing. Two or more methods can be combined to increase the purity of the obtained hydrogen. Regarding purification processes for hydrogen, reference can be made, for example, to Ullmann's Encyclopedia of Industrial Chemistry, Hydrogen, 3. Purification, DOI: 10.1002/14356007.o13_o04.

Therefore, the present invention is directed to a method
wherein the process stages (v) comprises
   (v) passing the stream S_{R} or the stream S′_{R} into the gas separation unit U_{PG}, obtaining S_{H} and a CO-rich stream S_{CO};
wherein the process stage (v′) comprises
   (v′) passing the stream S_{R} or the stream S′_{R} into the gas separation unit U_{PG}, obtaining S_{H} and a CO-rich stream S_{CO};
wherein the process stage (v″) comprises
   (v″) passing the stream S_{R} or the stream S′_{R} into the gas separation unit U_{PG}, obtaining S_{H} and a CO-rich stream S_{CO}.

If according to the method of the present invention, a CO-rich stream S_{CO} is obtained, it is preferred to put the stream S_{CO} to further use. Preferably, said further use comprises the use of S_{CO} for the synthesis of methanol with hydrogen, preferably with hydrogen from renewable sources.

### U_{P} Comprising a Water Gas Shift Reaction Unit and a Gas Separation Unit

According to a second embodiment of the present invention, the processing unit U_{P} comprises a gas separation unit U_{PG} and, upstream thereof, a water gas shift reaction unit U_{PW}. According to this embodiment,
the process stage (v) preferably comprises
   (v.1) passing the stream S_{R} or the stream S′_{R} into the water gas shift reaction unit U_{PW}, obtaining a stream SW comprising CO₂ and H₂;
   (v.2) passing the stream SW into the gas separation unit U_{PG}, obtaining S_{H} and a CO₂-rich stream S_{CO2};
the process stage (v′) comprises
   (v′0.1) passing the stream S_{R} or the stream S′_{R} into the water gas shift reaction unit U_{PW}, obtaining a stream SW comprising CO₂ and H₂;
   (v′0.2) passing the stream SW into the gas separation unit U_{PG}, obtaining S_{H} and a CO₂-rich stream S_{CO2};
the process stage (v″) comprises
   (v″. 1) passing the stream S_{R} or the stream S′_{R} into the water gas shift reaction unit U_{PW}, obtaining a stream SW comprising CO₂ and H₂;
   (v″0.2) passing the stream SW into the gas separation unit U_{PG}, obtaining S_{H} and a CO₂-rich stream S_{CO2}.

Further according to this second embodiment, the carbon monoxide comprised in the stream S_{R} or the stream S′_{R} is at least partially converted into additional hydrogen. In the water gas shift reaction, CO contained in the stream S_{R} or in the stream S′_{R} is reacted with H₂O to produce H₂ and CO₂. The shifted product stream obtained from the water gas shift process has higher concentrations of H₂ and CO₂ compared to the stream S_{R} or the stream S′_{R}. Preferably, the water gas shift reaction uses steam to shift CO to CO₂ and produces H₂ according to the following reaction:

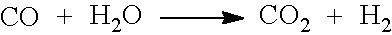

The water gas shift reaction is mildly exothermic and a favorable equilibrium on the CO₂ and H₂ side is obtained at low temperatures. Often, it is convenient to operate a single shift process at elevated temperatures to generate shifted gas mixtures with low CO contents (typically <10 mol-% on a dry gas basis). To achieve acceptable conversion, iron-containing catalysts have found widespread use as so-called high-temperature-shift (HTS) catalysts. These catalysts are typically provided as a particulate fixed bed in axial or radial-flow shift converters that are operated at inlet temperatures above 340° C. in order to achieve an acceptable activity. Alternatively, cobalt-molybdenum catalysts, which can be used in so-called “sour shift” processes, may be operated with inlet temperatures above 220° C. In addition to being a reactant, the steam also helps to move the equilibrium of the water gas shift reaction towards H₂, controlling the temperature rise from the exothermic water gas shift reaction, which if left unchecked could deactivate the catalyst. The steam is also required to prevent coking on the catalyst surface, which also deactivates the catalyst. Typically, the water gas shift process uses two reactors in series to carry out a high temperature shift (HTS) followed by a low temperature shift (LTS). Steam is added to the gas fed, i.e. the stream S_{R} or the stream S′_{R}, to the first reactor. The gas from the outlet of the first reactor is preferably cooled to the desired shift inlet temperature by adding more steam and the cooled gas is subsequently fed to the second reactor. From the second reactor, a shifted product stream, the stream S_{W} is obtained comprising additional hydrogen and carbon dioxide. Subsequently, according to (v.2), the carbon dioxide comprised in the shifted product stream S_{W} is separated to produce the hydrogen product stream S_{H} and the carbon dioxide-rich stream S_{CO2}. Remaining carbon monoxide or other impurities in the shifted product stream, respectively in the hydrogen product stream, can be separated by the means of gas separation as described above in the context of the first embodiment.

The separation of the carbon dioxide from the reformed stream S_{R} or S′_{R} if carried out in the context of the first embodiment or from the shifted product stream S_{W} according to the second embodiment has the advantage that CO₂ can be separated from a gas stream with a remarkably higher CO₂ concentration than a flue-gas stream originating from natural gas firing. This brings the advantages that smaller gas volumes can be treated to capture the emitted CO₂. The treatment of smaller gas volumes as well as the higher CO₂ concentration reduces the energy input needed for CO₂ capturing.

If according to the method of the present invention, a CO₂-rich stream S_{CO2} is obtained, it is preferred to put the stream S_{CO2} to further use. Preferably, said further use comprises the use of S_{CO2} comprises one or more of carbon capture and storage (CCS) and carbon capture utilization (CCU).

Typically, carbon capturing involves separating CO₂ from the stream S_{R} or S′_{R} or from the shifted product stream Sw. This may include capturing the CO₂ in liquid solvents. Subsequently, the capturing medium needs to be regenerated without releasing the CO₂ into the atmosphere. Typically, the liquid solvents used for CO₂ capturing are solutions of inorganic or organic bases.

On dissolving acid gases in the solvent, ion-pairs form with the bases. The solvent can be regenerated by expansion to a lower pressure or by stripping, the ionic species reacting back to form acid gases and/or being stripped off by means of steam. After the regeneration process, the solvent can be reused.

Generally, if CO₂ represents only a small percentage of a large volume of a gas stream to be treated, such as off-gas, treating a large flow stream to recover a small portion of it as CO₂ is wasteful and expensive. Unlike off-gas, the reformed stream S_{R} or S′_{R} and/or the shifted product stream S_{W} are streams exhibiting high CO₂ concentrations and therefore, CO₂ capturing from these streams is more efficient in view of energy input for CO₂ separation.

Suitably, the absorption liquid medium is an aqueous solution of at least one amine having a total amine content in the range of from 30 to 70 weight-%, preferably in the range 40 to 60 weight-%. Preferably, the amine is selected from monoethanolamine (MEA), methylaminopropylamine (MAPA), piperazine, diethanolamine (DEA), triethanolamine (TEA), diethylethanolamine (DEEA), diisopropylamine (DIPA), aminoethoxyethanol (AEE), dimethylaminopropanol (DIMAP), methyldiethanolamine (MDEA), methyldiisopropanolamine (MDIPA), 2-amino-1-butanol (2-AB), or mixtures thereof. Preferred absorption media comprise at least one alkanolamine having 4 to 12 carbon atoms. Particularly preferred absorption media comprise at least one tertiary alkanolamine and preferably an activator in the form of a primary or secondary amine. Preferred activators are saturated, 5- to 7-membered heterocyclic compounds having at least one NH group and, if appropriate, a further heteroatom in the ring selected from an oxygen atom and a nitrogen atom. For example, suitable activators are selected from piperazine, 1-methylpiperazine, 2-methylpiperazine, 1-aminoethylpiperazine, morpholine and piperidine. Other preferred activators are selected from methylaminopropylamine, 2-amino-1-butanol or aminoethoxyethanol.

In order to avoid problems in downstream processes such as CCS or CCU, the obtained water-containing, i.e. wet, carbon dioxide-containing stream is preferably treated for removing H₂O. Thus, the carbon dioxide-containing stream, in particular S_{CO2}, is preferably subjected to a drying step to obtain a dried carbon dioxide-containing stream. Typically, such drying step is carried out using at least one vessel containing at least one desiccant for adsorbing H₂O from the wet carbon dioxide-containing stream. For this purpose, the wet carbon dioxide-containing stream is preferably passed over the desiccant in one direction. Subsequently, the desiccant is preferably regenerated. For desiccant regeneration, the flow through the desiccant bed is preferably carried out in the reverse direction. Preferred setups include two dryers wherein one is in operation mode whilst the other is in standby more, and in regeneration mode, respectively. Preferably, the dried carbon dioxide-containing stream is suitably liquefied or brought into its supercritical stage and subsequently subjected to carbon dioxide sequestration. Carbon dioxide sequestration of CO₂ originating from renewable resources is a so called “negative emission technology”. A negative emission technology removes, i.e. captures, carbon dioxide equivalents from the atmosphere by sequestering, i.e. storing, the carbon dioxide for long periods of time. In other words, CO₂ may be removed from the atmosphere by carbon dioxide sequestration. These negative emission technologies aim at combating the current levels of greenhouse gas carbon dioxide and their projected rate of increase. Thus, negative emission technologies can include enhanced carbon sinks that provide for long-term storage of the removed carbon dioxide.

For example, carbon dioxide sequestration, also referred to as “carbon capture and storage” (CCS), may involve “geological carbon sequestration” such as hydrodynamic trapping, solubility trapping or mineral trapping. Geological carbon sequestration involves storing the captured and dried carbon dioxide-containing stream underneath the surface of the earth, e.g. by pumping the same into pores of underground geological formations or into deep ocean layers. Further examples of negative emission technologies include terrestrial carbon sequestration, coastal blue carbon capture, and mineral carbonation of carbon dioxide. Generally, terrestrial carbon sequestration entails increasing forestation and agricultural soil carbon content, while coastal blue carbon sequestration focuses on similar processes at tidal or wetland areas. Mineral carbonation refers to atmospheric or captured carbon dioxide being contacted with basaltic or ultramafic rocks to undergo a chemical reaction to convert the carbon dioxide into a chemical solid.

Preferably according to the present invention, the dried carbon dioxide-containing stream is subjected to carbon dioxide utilization (CCU). Carbon dioxide utilization, also referred to as “carbon dioxide capture and utilization” aims at recycling captured carbon dioxide for converting the same to useful solid or liquid materials such as methanol, olefins, plastics, carbon fibers, biomass such as biofuel (“bioenergy carbon capture and storage”), carbon-based chemicals etc. Bioenergy carbon capture entails capturing the dried carbon dioxide-containing stream and using the captured carbon dioxide in a biomass that is used in fuels. In case the CO₂ originates from renewable resources, carbon dioxide capture and utilization is also an example of a “negative emission technology”.

### The Method of Controlling the Process

According to the method of the present invention, the process carried out in the integrated plant is controlled in a suitable manner so that the heat demand E_{UC} of the hydrocarbon conversion process carried out in the unit U_{C} can be met, in case the amount of heat which can be supplied by external and sustainable heat sources H_{EXT-S} is too low, at least partially by using hydrogen as a heat source for U_{C}, which hydrogen is comprised in a gas stream which in turn is suitably obtained from an off-gas stream of said unit U_{C}.

Further according to the present invention, this method comprises the determination of the heat demand E_{UC} of the hydrocarbon conversion carried out in the unit U_{C}. Depending on, e.g., the specific chemical composition of the at least one hydrocarbon feed stream S_{F} which is passed into U_{C} and/or the specific reaction conditions of the hydrocarbon conversion process carried out in U_{C} which composition and/or conditions may vary over time during the hydrocarbon conversion process, said heat demand E_{UC} may also vary over time. Yet further, as indicated above, the amount of heat which can be provided by the plant-external sustainable heat sources H_{EXT-S} may vary over time, e.g. due to general supply issues such as costs involved for purchasing suitable heat sources H_{EXT-S}, or supply interruptions due to maintenance intervals. All of these different possible influences can be dealt with by the control method of the present invention which renders said process highly flexible.

According to the method of the present invention according to (a), the heat demand of E_{UC} of U_{C} is suitably determined. This determination can be carried out continuously or semi-continuously at respective intervals which depend on the varying parameters having an impact on the hydrocarbon conversion process in U_{C} as described above. Further according to the method of the present invention according to (b), the amount E_{EXT-S} of heat available for U_{C} from the one or more plant-external sustainable heat sources H_{EXT-S} is determined continuously or semi-continuously at respective intervals which depend on the varying parameters having an impact on the hydrocarbon conversion process in U_{C} as described above. As a result from the values for E_{UC} and E_{EXT-S} determined according to (a) and (b), it is known at every desired point in time during the hydrocarbon process if the heat demand E_{UC} can be met by E_{EXT-S} by determining the value of ΔE=E_{UC}−E_{EXT}, i.e. by straight-forward calculation.

### ΔE>0

If the determination of ΔE as described above leads to a positive value, ΔE>0, at least a certain amount of additional plant-internal heat is necessary to suitably meet the energy demand of and, thus, to maintain the hydrocarbon conversion process in U_{C}.

In particular, according to the present invention, the amount of hydrogen H_{2N} is then determined which needs to be provided as heat source to M_{H} in order to produce heat in an amount of ΔE. Yet further, according to the present invention, the amount of hydrogen H_{2P} is then determined, the maximum amount of H₂ which can be produced in U_{R} and U_{P} and, thus, the maximum amount of H₂ which can be achieved in the stream S_{H}. Based this amount H_{2P}, heat can be produced in M_{H} in an amount of E_{H2P}.

### ΔE>0 and ΔH>0

If a comparison of the values H_{2N} and H_{2P} leads to the conclusion that ΔH=H_{2N}−H_{2P} is greater than zero, i.e. that the heat demand ΔE cannot be met by H_{2P} alone, it is particularly preferred that said maximum amount H_{2P} is passed via the stream S′_{H} into M_{H}. The supply means M_{E}, the processing unit U_{P} and optionally the supply means M_{R} are suitably controlled to provide the maximum amount H_{2P} to M_{H} via S′_{H} so that E_{H2P} can be produced in My. It is noted that it may be possible, also in this case where ΔH>0, not to pass the maximum amount H_{2P} into M_{H}, for example in case if other plant-internal sustainable heat sources might be available which could suitably replace a part of H_{2P} when passed into M_{H}; however, passing the maximum amount H_{2P} to M_{H} is generally particularly preferred.

According to this scenario, the process comprises, depending on whether the plant contains the means M_{R} or not,
(iv) optionally passing S_{R} obtained from U_{R} through M_{R}, obtaining a stream S′_{R} being x volume-% of S_{R}, with x=100;
(v) passing the stream S_{R} or, if (iv) is carried out, the stream S′_{R} into U_{P}, obtaining S_{H};
(vi) passing the stream S_{H} obtained from U_{P} through M_{E}, obtaining a stream S′_{H} being y volume-% of S_{H}, with y=100;
(vii) passing the stream S′_{H} obtained from M_{E} as H_{INT} into M_{H}.

Since, as discussed above, the energy demand ΔE cannot be met by H_{2P} according to this process scenario, at least one additional heat source must be passed to M_{H} in order to produce sufficient heat to maintain the hydrocarbon conversion process. While it may be generally conceivable that said at least one additional heat source may be available plant-internally, the at least one additional heat source is usually provided via a plant-external fossil heat source. Therefore, the process preferably comprises, further to (iv), (v), (vi) and (vii) above,
(viii) passing at least one of the one or more plant-external fossil heat sources H_{EXT-F} via M_{E} into M_{H} in an amount sufficient to generate heat in an amount (ΔE−E_{H2P}) in M_{H}.

If according to the above, ΔE>0 and ΔH>0, the processing unit U_{P} comprises a gas separation unit U_{PG}, the process stage (v) comprises
(v) passing the stream S_{R} or the stream S′_{R} into the gas separation unit U_{PG}, obtaining S_{H} and a CO-rich stream S_{CO};
   wherein the stream S_{CO} is preferably put to further use, wherein said further use preferably comprises the use of S_{CO} for the synthesis of methanol with hydrogen, preferably with hydrogen from renewable sources.

Within the possible limits of the respective gas separation method applied in (v), the composition of the stream S_{H} can be controlled so that the maximal possible amount of H₂ can be provided to M_{H} via S′_{H}.

If the processing unit U_{P} comprises a gas separation unit U_{PG} and a water gas shift reaction unit U_{PW}, the process stage (v) comprises
(v.1) passing the stream S_{R} or the stream S′_{R} into the water gas shift reaction unit U_{PW}, obtaining a stream S_{W} comprising CO₂ and H₂;
(v.2) passing the stream S_{W} into the gas separation unit U_{PG}, obtaining S_{H} and a CO₂-rich stream S_{CO2}.

In this case, it is preferred that the stream S_{CO2} or a part thereof is put to further use, wherein said further use preferably comprises one or more of carbon capture and storage (CCS) and carbon capture utilization (CCU).

Within the possible limits of the respective water gas shift reaction and the respective gas separation method applied in (v), the composition of the stream S_{H} can be controlled so that the maximal possible amount of H₂ can be provided to My via S′_{H}.

The hydrogen-rich stream S_{H} obtained from U_{P} is then passed through the supply means M_{E} according to (vi) to obtain a stream S′_{H} being y volume-% of S_{H}, with y=100.

### ΔE>0 and ΔH≤0

If a comparison of the values H_{2N} and H_{2P} leads to the conclusion that ΔH=H_{2N}−H_{2P} is less than or equal to than zero, i.e. that the heat demand ΔE can be met by H_{2P} alone, the supply means M_{E}, the processing unit U_{P} and optionally the supply means M_{E} are suitably controlled to provide the necessary amount of plant-internal H₂ to M_{H} via S′_{H} so that ΔE can be produced in M_{H}.

According to this scenario, the process comprises, depending on whether the plant contains the means M_{R} or not,
(iv′) optionally passing S_{R} obtained from U_{R} through M_{R}, obtaining a stream S′_{R} being x volume-% of S_{R}, with 0<x≤100;
(v′) passing the stream S_{R} or, if (iv) is carried out, the stream S′_{R} into U_{P}, obtaining S_{H};
(vi′) passing the stream S_{H} obtained from U_{P} through M_{E}, obtaining a stream S′_{H} being y volume-% of S_{H}, with 0<y≤100;
(vii′) passing the stream S′_{H} obtained from M_{E} as H_{INT} into M_{H}.

Since for ΔE>0, H₂ contained in S_{H} must be provided, the stream S′_{R} which is obtained from the means M_{R} according to process step (iv′), if present, needs to be x volume-% of S_{R}, with 0<x≤100, i.e. x must not be zero. The exact value of x will depend, on the one hand, of the value of ΔE and, additionally, of the parameters at which the processing unit U_{P} the means M_{E} can be or shall be operated, i.e. which stream S′_{R} must be provided to U_{P} in order to achieve a certain stream S_{H} which in turn is passed to the means M_{E} to obtain the ultimately desired stream S′_{H} to be provided to the means M_{H}. In particular, it is possible to pass the stream S_{R} through M_{R} without any change in composition and/or volume, in which case x=100. However, also in this case, the presence of M_{R} is not useless since it can be used for separating a stream S″_{R} whenever the control of the overall requires x<100 for which case the process stage (iv′) comprises
(iv′) passing S_{R} obtained from U_{R} through M_{R}, obtaining a stream S′_{R} being x volume-% of S_{R}, with 0<x<100, and obtaining a stream S″_{R} being (100-x) volume-% of S_{R}.

Preferably, at least a part of the stream S″_{R} is put to further use, wherein said further use more preferably comprises the use of S″_{R} as synthesis gas, more preferably comprises the use of S″_{R} as synthesis gas for producing one or more of methanol, a liquid fuel, a hydrocarbon, a lubricant, an oxoalcohol and ammonia.

The respectively obtained stream S′_{R} from M_{R}, or the stream S_{R}, is then passed according to (v′) to the processing unit U_{P} from which the hydrogen-rich stream S_{H} is obtained. The process stage or the process stages carried out in U_{P} are then suitably controlled in such a manner that the ultimately obtained stream S_{H} contains a sufficient amount of hydrogen to produce ΔE in M_{H}.

If according to the above, ΔE>0 and H≤0, the processing unit U_{P} comprises a gas separation unit U_{PG}, the process stage (v) comprises
(v′) passing the stream S_{R} or the stream S′_{R} into the gas separation unit U_{PG}, obtaining S_{H} and a CO-rich stream S_{CO};
   wherein the stream S_{CO} is preferably put to further use, wherein said further use preferably comprises the use of S_{CO} for the synthesis of methanol with hydrogen, preferably with hydrogen from renewable sources.

Within the possible limits of the respective gas separation method applied in (v′), the composition of the stream S_{H} can be controlled so that its hydrogen content is sufficient for ΔE to be produced in M_{H}.

If the processing unit U_{P} comprises a gas separation unit U_{PG} and a water gas shift reaction unit U_{PW}, the process stage (v′) comprises
(v′0.1) passing the stream S_{R} or the stream S′_{R} into the water gas shift reaction unit U_{PW}, obtaining a stream S_{W} comprising CO₂ and H₂;
(v′0.2) passing the stream S_{W} into the gas separation unit U_{PG}, obtaining S_{H} and a CO₂-rich stream S_{CO2}.

In this case, it is preferred that the stream S_{CO2} or a part thereof is put to further use, wherein said further use preferably comprises one or more of carbon capture and storage (CCS) and carbon capture utilization (CCU).

Within the possible limits of the respective water gas shift reaction and the respective gas separation method applied in (v′), the composition of the stream S_{H} can be controlled so that its hydrogen content is sufficient for ΔE to be produced in M_{H}.

The hydrogen-rich stream S_{H} obtained from U_{P} is then passed through the supply means M_{E} according to (vi′) to obtain a stream S′_{H} being y volume-% of S_{H}, with 0<y≤100. Since ΔE to be produced in M_{H} is greater than zero, y must be greater than zero. The exact value of y will depend, on the amount of hydrogen necessary for ΔE to be produced in M_{H}. According to this scenario, it is possible to use the entire stream S_{H} as the stream S′_{H} to be supplied to M_{H} in which case y=100. If more hydrogen is comprised in S_{H} then necessary for ΔE to be produced in M_{H}, it is preferred that the means M_{E} are controlled in such a manner that process stage (vi′) comprises
(vi′) passing the stream S_{H} obtained from U_{P} through M_{E}, obtaining a stream S′_{H} being y volume-% of S_{H}, with 0<y<100, and obtaining a stream S″_{H} being (100-y) volume-% of S_{H}.

Preferably according to the present invention, from 60 to 100 volume-%, more preferably from 70 to 100 volume-%, more preferably from 80 to 100 volume-%, more preferably from 90 to 100 volume-%, more preferably from 95 to 100 volume-%, more preferably from 99 to 100 volume-% of the H₂-rich stream S_{H} consist of H₂.

In this case, it is preferred that wherein the stream S″_{H} or a part stream thereof is put to further use, wherein said further use preferably comprises the use of S″_{H} as a heat source in one or more units other than U_{C}. More preferably, in said one or more units other than U_{C}, S″_{H} or a part stream thereof is used as a heat source for one or more endothermic processes carried out at a temperature of at least 800° C., for the generation of steam or generally for combustion.

If the stream S_{H} which is passed into M_{E} and separated there in a stream S′_{H} to be passed to M_{H} and a stream S″_{H}, said separation can be carried out, for examples, using one or more controllable valves.

### ΔE≤0

If the determination of ΔE leads to a non-positive value, ΔE≤0, then no additional plant-internal heat is necessary to maintain the hydrocarbon conversion process in U_{C}. In this scenario, the processing unit U_{P}, the supply means M_{E} and optionally the supply means M_{R} are controlled in such a manner so that no H₂ is passed into M_{H} via S_{H}.

According to this scenario, the process comprises, depending on whether the plant contains the means M_{R} or not,
(iv″) optionally passing S_{R} obtained from U_{R} through M_{R}, obtaining a stream S′_{R} being x volume-% of S_{R}, with 0≤x≤100;
(v″) passing the stream S_{R} or, if (iv′) is carried out and x≠0, the stream S′_{R} into U_{P}, obtaining S_{H};
(vi″) passing the stream S_{H}, if obtained from U_{P}, through M_{E}, obtaining a stream S″_{H} being 100 volume-% of S_{H};
(vii″) removing the stream S″_{H} from M_{E}.

Therefore, it is possible that, if x=0, no stream S′_{R} is obtained from M_{R}, if present, which would be passed to the processing unit U_{P}. In this case, the entire stream S_{R} is passed through M_{R} to obtain the stream S″_{R} which is identical to S_{R}. Also, it is possible that, if x=100, no stream S″_{R} is obtained from M_{R}, if present, which would be separated from S_{R}. In this case, the entire stream S_{R} is passed through M_{R} to obtain the stream S′_{R} which is identical to S_{R}. For all cases in which a stream S″_{R} is obtained, i.e. process stage (iv″) comprises
(iv″) passing S_{R} obtained from U_{R} through M_{R}, obtaining a stream S′_{R} being x volume-% of S_{R}, with 0≤x<100, and obtaining a stream S″_{R} being (100-x) volume-% of S_{R},
   it is preferred to put at least a part of the stream S″_{R} to further use, wherein said further use more preferably comprises the use of S″_{R} as synthesis gas, more preferably comprises the use of S″_{R} as synthesis gas for producing one or more of methanol, a liquid fuel, a hydrocarbon, a lubricant, an oxoalcohol and ammonia.

If x≠0, the respectively obtained stream S′_{R} from M_{R}, or the stream S_{R}, is then passed according to (v′) to the processing unit U_{P} from which the hydrogen-rich stream S_{H} is obtained.

If according to the above-described first embodiment, the processing unit U_{P} comprises a gas separation unit U_{PG}, the process stage (v′) comprises for x≠0
(v′) passing the stream S_{R} or the stream S′_{R} into the gas separation unit U_{PG}, obtaining S_{H} and a CO-rich stream S_{CO};
   wherein the stream S_{CO} is preferably put to further use, wherein said further use preferably comprises the use of S_{CO} for the synthesis of methanol with hydrogen, preferably with hydrogen from renewable sources.

If according to the above, where ΔE≤0, the processing unit U_{P} comprises a gas separation unit U_{PG} and a water gas shift reaction unit U_{PW}, the process stage (v″) comprises for x≠0
(v″. 1) passing the stream S_{R} or the stream S′_{R} into the water gas shift reaction unit U_{PW}, obtaining a stream S_{W} comprising CO₂ and H₂;
(v″0.2) passing the stream S_{W} into the gas separation unit U_{PG}, obtaining S_{H} and a CO₂-rich stream S_{CO2}.

In this case, it is preferred that the stream S_{CO2} or a part stream thereof is put to further use, wherein said further use preferably comprises one or more of carbon capture and storage (CCS) and carbon capture utilization (CCU).

Further for x≠0, the stream S_{H} obtained from U_{P} is then passed to the supply means M_{E}. Since no hydrogen comprised in S_{H} is needed in addition to H_{EXT} to produce E_{UC}, no stream S′_{H} is supplied by M_{E} to M_{H}, and the means M_{E} are controlled in such a manner the entire stream S_{H} is obtained as the stream S″_{H}. In this case, it is preferred that the stream S″_{H} or a part stream thereof is put to further use, wherein said further use more preferably comprises the use of S″_{H} as a heat source in one or more units other than U_{C}. More preferably, in said one or more units other than U_{C}, S″_{H} or a part stream thereof is used as a heat source for one or more endothermic processes carried out at a temperature of at least 800° C., for the generation of steam or generally for combustion.

Preferably, the method of controlling the process according to the present invention makes use of a computer-supported control system with which one or more of the above-described parameters are determined and one or more of the above-described units and/or means and/or processes are controlled based on said one or more parameters in order to achieve the desired process design.

Still further, the present invention relates to an integrated production plant, comprising
(1) supply means M_{F} for providing one or more hydrocarbon feed streams S_{F} to a unit U_{C} for heat-consuming hydrocarbon conversion, wherein the supply means M_{F} are connected to U_{C} for passing at least one of said hydrocarbon feed stream S_{F} into U_{C} to obtain from U_{C} one or more product streams S and a light hydrocarbon conversion off-gas stream S_{O} comprising CH₄;
(2) the unit U_{C} which comprises heating means M_{H} for providing heat to the hydrocarbon conversion, wherein said heating means M_{H} comprise means for generating heat from one or more heat sources H_{S} and wherein said one or more heat sources H_{S} comprise H₂;
(3) controllable supply means M_{E} for providing one or more plant-external sustainable heat sources H_{EXT-S} one or more plant-external sustainable fossil heat sources H_{EXT-F} and one or more plant-internal heat sources H_{INT}, said plant-internal heat sources H_{INT} comprising H₂, wherein the supply means M_{E} are connected to U_{C} for passing at least one of said heat sources H_{EXT-S}, H_{EXT-F} and H_{INT} to the heating means M_{H};
(4) a reforming unit U_{R} for subjecting the light hydrocarbon conversion off-gas stream S_{O} to reforming to obtain a product gas stream S_{R} comprising CO and H₂, wherein U_{R} is arranged downstream of U_{C} and connected to U_{C} for passing S_{O} into U_{R};
(5) a controllable processing unit U_{P} for processing S_{R} to produce a stream S_{H} being enriched in H₂ compared to S_{R}, wherein U_{P} is arranged downstream of U_{R} and connected to U_{R} for passing S_{R} into U_{P};
(6) and optionally controllable supply means M_{R} for optionally dividing the stream S_{R} into the part stream S′_{R} and a stream S″_{R}, wherein M_{R} is arranged downstream of U_{R} and upstream of U_{P}, connected to U_{R} for passing S_{R} into M_{R} and connected to U_{P} for passing S′_{R} or S″_{R} into U_{P}.

Preferably, the unit U_{C} for heat-consuming hydrocarbon conversion comprises a cracking unit U_{CC}, preferably a thermal cracking unit, more preferably a steam cracking unit. More preferably, the unit U_{C} further comprises a separation unit U_{S} for treating a cracked gas stream S_{C}, wherein U_{S} comprises at least one demethanizing unit, wherein from said demethanizing unit the stream S_{O} is obtained and wherein from US, the one or more product streams are obtained.

According to a first embodiment, the unit U_{P} comprises a gas separation unit U_{PG} for obtaining, from S_{R} or S′_{R}, the stream S_{H} and a CO-rich stream S_{CO}. According to a second embodiment, the unit U_{P} comprises a water gas shift reaction unit U_{PW} for obtaining, from S_{R} or S′_{R}, a stream S_{W} comprising CO₂ and H₂, and further comprises, arranged downstream of U_{PW}, a gas separation unit U_{PG} for obtaining, from S_{W}, the stream S_{H} and a CO₂-rich stream S_{CO2}.

Preferably, in another embodiment, the integrated production plant comprises a means for passing H₂ into M_{H} via S_{H}. The means preferably allows for additional heat to least partially be provided via the heat source H₂ comprised in the stream S_{H} obtained from the processing unit U_{P}.

Still further, the present invention also relates to the use of the integrated production plant as described above for carrying out the method as described above.

The present invention is further illustrated by the following set of embodiments and combinations of embodiments resulting from the dependencies and back-references as indicated. In particular, it is noted that in each instance where a range of embodiments is mentioned, for example in the context of a term such as “The method of any one of embodiments 1 to 4”, every embodiment in this range is meant to be explicitly disclosed for the skilled person, i.e. the wording of this term is to be understood by the skilled person as being synonymous to “The method of any one of embodiments 1, 2, 3 and 4”. Further, it is explicitly noted that the following set of embodiments represents a suitably structured part of the general description directed to preferred aspects of the present invention, and, thus, suitably supports, but does not represent the claims of the present invention.
1. A method for controlling a process carried out in an integrated production plant, wherein the integrated production plant comprises
   (1) supply means M_{F} for providing one or more hydrocarbon feed streams S_{F} to a unit U_{C} for heat-consuming hydrocarbon conversion to obtain from U_{C} one or more product streams S and a light hydrocarbon conversion off-gas stream S_{O} comprising CH₄;
   (2) the unit U_{C} which comprises heating means M_{H} for providing heat to the hydrocarbon conversion, wherein said heating means Mu comprise means for generating heat from one or more heat sources H_{S} and wherein said one or more heat sources H_{S} comprise H₂;
   (3) controllable supply means M_{E} for providing one or more plant-external sustainable heat sources H_{EXT-S}, one or more plant-external fossil heat sources H_{EXT-F}, and one or more plant-internal heat sources H_{INT}, said plant-internal heat sources H_{INT} comprising H₂, for passing at least one of said heat sources H_{EXT-S}, H_{EXT-F} and H_{INT} to the heating means M_{H};
   (4) a reforming unit U_{R} for subjecting the light hydrocarbon conversion off-gas stream S_{O} to reforming to obtain a product gas stream S_{R} comprising CO and H₂;
   (5) a controllable processing unit U_{P} for processing S_{R} or a part stream S′_{R} thereof to obtain a stream S_{H} being enriched in H₂ compared to S_{R} or S′_{R};
   (6) and optionally comprises controllable supply means M_{R} for optionally dividing the stream S_{R} into the part stream S′_{R} and a stream S″_{R}, and for passing S′_{R} into U_{P};
wherein the process comprises
   (i) passing one or more heat sources according to (3) from M_{E} to M_{H} in an amount sufficient for generating heat in My meeting the heat demand E_{UC} of the hydrocarbon conversion in U_{C};
   (ii) passing at least one hydrocarbon feed stream S_{F} into U_{C} and subjecting the at least one feed stream S_{F} to hydrocarbon conversion in U_{C}, obtaining the one or more product streams S and S_{O};
   (iii) passing S_{O} into U_{R} and subjecting S_{O} to reforming in U_{R}, obtaining S_{R};
wherein the method for controlling the process comprises
   (a) determining the heat demand E_{UC} of the hydrocarbon conversion in U_{C} to be provided by M_{H};
   (b) determining the amount E_{EXT-S} of heat available for U_{C} from the one or more plant-external sustainable heat sources H_{EXT-S};
   (c) determining ΔE=E_{UC}−E_{EXT-S} and
      (c.1) if ΔE>0,
         (c. 1.1) determining H_{2N}, the amount of H₂ necessary to produce ΔE in M_{H};
         (c. 1.2) determining H_{2P}, the maximum amount of H₂, producible in U_{R} and U_{P} to be contained in S_{H}, to produce an amount E_{H2P} of heat in M_{H};
         (c. 1.3) determining ΔH=H_{2N}−H_{2P}; and
         (c. 1.3.1) if ΔH>0,
         controlling the processing unit U_{P}, the supply means M_{E} and optionally the supply means M_{R} so that H_{2P} is passed into M_{H} via S_{H};
         wherein the process further comprises
         (iv) optionally passing S_{R} obtained from U_{R} through M_{R}, obtaining a stream S′_{R} being x volume-% of S_{R}, with x=100;
         (v) passing the stream S_{R} or, if (iv) is carried out, the stream S′_{R} into U_{P}, obtaining S_{H};
         (vi) passing the stream S_{H} obtained from U_{P} through M_{E}, obtaining a stream S′_{H} being y volume-% of S_{H}, with y=100;
         (vii) passing the stream S′_{H} obtained from M_{E} as H_{INT} into M_{H};
         (viii) passing at least one of the one or more plant-external fossil heat sources H_{EXT-F} via M_{E} into M_{H} in an amount sufficient to generate heat in an amount (ΔE−E_{H2P}) in M_{H};
         (c. 1.3.2) if ΔH≤0,
         controlling the processing unit U_{P}, the supply means M_{E} and optionally the supply means M_{R} so that an amount of H₂ is passed into M_{H} via S_{H} which is sufficient to produce ΔE in M_{H};
         wherein the process further comprises
         (iv′) optionally passing S_{R} obtained from U_{R} through M_{R}, obtaining a stream S′_{R} being x volume-% of S_{R}, with 0<x≤100;
         (v′) passing the stream S_{R} or, if (iv) is carried out, the stream S′_{R} into U_{P}, obtaining S_{H};
         (vi′) passing the stream S_{H} obtained from U_{P} through M_{E}, obtaining a stream S′_{H} being y volume-% of S_{H}, with 0<y≤100;
         (vii′) passing the stream S′_{H} obtained from M_{E} as H_{INT} into M_{H};
      (c.2) if ΔE≤0,
         controlling the processing unit U_{P}, the supply means M_{E} and optionally the supply means M_{R} so that no H₂ is passed into My via S_{H};
         wherein the process further comprises
         (iv″) optionally passing S_{R} obtained from U_{R} through M_{R}, obtaining a stream S′_{R} being x volume-% of S_{R}, with 0≤x≤100;
         (v″) passing the stream S_{R} or, if (iv′) is carried out and x≠0, the stream S′_{R} into U_{P}, obtaining S_{H};
         (vi″) passing the stream S_{H}, if obtained from U_{P}, through M_{E}, obtaining a stream S″_{H} being 100 volume-% of S_{H};
         (vii″) removing the stream S″_{H} from M_{E}.
2. The method of embodiment 1, wherein from 40 to 100 volume-%, preferably from 60 to 100 volume-%, more preferably from 80 to 100 volume-%, more preferably from 90 to 100 volume-%, more preferably from 95 to 100 volume-% of S_{O} consist of CH₄.
3. The method of embodiment 1 or 2, wherein the unit U_{C} for heat-consuming hydrocarbon conversion comprises a cracking unit U_{CC}, preferably a thermal cracking unit, more preferably a steam cracking unit.
4. The method of embodiment 3, wherein U_{C} further comprises a separation unit US, wherein according to (ii), the process comprises
   (ii.1) passing at least one hydrocarbon feed stream S_{F} into U_{C} and subjecting the at least one feed stream S_{F} to hydrocarbon conversion in U_{C}, obtaining a cracked gas stream S_{C};
   (ii.2) passing the cracked gas stream S_{C} obtained according to (ii.1) to a separation unit U_{S} comprising at least one demethanizing unit, obtaining from said demethanizing unit the stream S_{O}, wherein from U_{S}, the one or more product streams S are obtained.
5. The method of embodiment 4, wherein the demethanizing step according to (ii.2) comprises a distillation step from which an overhead stream S_{O1} is obtained comprising CH₄ and H₂, and preferably further comprises a separation step wherein Son is separated into a H₂-rich stream and a CH₄-rich stream S_{O2}, wherein Son or a partial stream thereof, preferably S_{O2} or a partial stream thereof, is subjected as the stream S_{O} into U_{R} according to (iii).
6. The method of any one of embodiments 1 to 5, preferably of any one of embodiments 3 to 5, wherein from 96 to 100 volume-%, preferably from 98 to 100 volume-%, more preferably from 99 to 100 volume-%, more preferably from 99.9 to 100 volume-% of S_{O} consists of CH₄.
7. The method of any one of embodiments 1 to 6, preferably of embodiment 6, wherein from 0 to 4 volume-%, preferably from 0 to 2 volume-%, more preferably from 0 to 1 volume-%, more preferably from 0 to 0.1 volume-% of S_{O} consist of H₂.
8. The method of any one of embodiments 1 to 7, wherein the one or more hydrocarbon feed streams S_{F} comprise at least one of a hydrocarbon feed stream comprising, preferably consisting of, fossil hydrocarbons; a hydrocarbon feed stream comprising, preferably consisting of, recycled hydrocarbons; and a hydrocarbon feed stream comprising, preferably consisting of, biohydrocarbons.
9. The method of any one of embodiments 1 to 8, wherein the one or more plant-external sustainable heat sources H_{EXT-S} according to (3) comprise one or more of solar energy, wind energy, hydro energy, tidal energy, geothermal energy, and biomass energy, ammonia obtained from renewable sources, biomethane, bio-LNG and H₂ obtained from renewable sources, wherein the plant-external fossil heat sources H_{EXT-F} according to (3) preferably comprise one or more of coal, oil and gas.
10. The method of any one of embodiments 1 to 9, wherein the reforming unit U_{R} according to (4) comprises one or more of an autothermal reforming (ATR) unit, a steam reforming (STR) unit, and a partial oxidation (POX) unit, preferably one or more of an autothermal reforming (ATR) unit and a steam reforming (STR) unit.
11. The method of any one of embodiments 1 to 10, wherein in the product gas stream S_{R} obtained from the reforming unit U_{R}, the molar ratio CO:H₂ is in the range of 1:2 to 1:3.
12. The method of any one of embodiments 1 to 11, wherein for ΔE>0 and ΔH>0, the process stage (iv) comprises
   (iv) passing S_{R} obtained from U_{R} through M_{R}, obtaining a stream S′_{R} being x volume-% of S_{R}, with x=100.
13. The method of any one of embodiments 1 to 11, wherein for ΔE>0 and ΔH≤0, the process stage (iv′) comprises
   (iv′) passing S_{R} obtained from U_{R} through M_{R}, obtaining a stream S′_{R} being x volume-% of S_{R}, with 0<x<100, and obtaining a stream S″_{R} being (100-x) volume-% of S_{R}.
14. The method of any one of embodiments 1 to 13, wherein for ΔE≤0, the process stage (iv″) comprises
   (iv″) passing S_{R} obtained from U_{R} through M_{R}, obtaining a stream S′_{R} being x volume-% of S_{R}, with 0≤x<100, and obtaining a stream S″_{R} being (100-x) volume-% of S_{R}.
15. The method of embodiment 13 or 14, wherein at least a part of the stream S″_{R} is put to further use, wherein said further use preferably comprises the use of S″_{R} as synthesis gas, more preferably comprises the use of S″_{R} as synthesis gas for producing one or more of methanol, a liquid fuel, a hydrocarbon, a lubricant, an oxoalcohol and ammonia.
16. The method of any one of embodiments 1 to 15, wherein the processing unit U_{P} according to (5) comprises one or more of a gas separation unit U_{PG} and a water gas shift reaction unit U_{PW}.
17. The method of embodiment 16, wherein the processing unit U_{P} comprises a gas separation unit U_{PG}, wherein for ΔE>0 and ΔH>0, the process stage (v) comprises
   (v) passing the stream S_{R} or the stream S′_{R} into the gas separation unit U_{PG}, obtaining S_{H} and a CO-rich stream S_{CO};
wherein the stream S_{CO} is preferably put to further use, wherein said further use preferably comprises the use of S_{CO} for the synthesis of methanol with hydrogen, preferably with hydrogen from renewable sources.
18. The method of embodiment 16, wherein the processing unit U_{P} comprises a gas separation unit U_{PG} and a water gas shift reaction unit U_{PW}, wherein for ΔE>0 and ΔH>0, the process stage (v) comprises
   (v.1) passing the stream S_{R} or the stream S′_{R} into the water gas shift reaction unit U_{PW}, obtaining a stream S_{W} comprising CO₂ and H₂;
   (v.2) passing the stream S_{W} into the gas separation unit U_{PG}, obtaining S_{H} and a CO₂-rich stream S_{CO2};
wherein the stream S_{CO2} is preferably put to further use, wherein said further use preferably comprises one or more of carbon capture and storage (CCS) and carbon capture utilization (CCU).
19. The method of any one of embodiments 16 to 18, wherein the processing unit U_{P} comprises a gas separation unit U_{PG}, wherein for ΔE>0 and ΔH≤0, the process stage (v′) comprises
   (v′) passing the stream S_{R} or the stream S′_{R} into the gas separation unit U_{PG}, obtaining S_{H} and a CO-rich stream S_{CO};
   wherein the stream S_{CO} is preferably put to further use, wherein said further use preferably comprises the use of S_{CO} for the synthesis of methanol with hydrogen, preferably with hydrogen from renewable sources.
20. The method of embodiment of any one of embodiments 16 to 18, wherein the processing unit U_{P} comprises a gas separation unit U_{PG} and a water gas shift reaction unit U_{PW}, wherein for ΔE>0 and ΔH≤0, the process stage (v′) comprises
   (v′. 1) passing the stream S_{R} or the stream S′_{R} into the water gas shift reaction unit U_{PW}, obtaining a stream S_{W} comprising CO₂ and H₂;
   (v′0.2) passing the stream S_{W} into the gas separation unit U_{PG}, obtaining S_{H} and a CO₂-rich stream S_{CO2};
   wherein the stream S_{CO2} is preferably put to further use, wherein said further use preferably comprises one or more of carbon capture and storage (CCS) and carbon capture utilization (CCU).
21. The method of any one of embodiments 16 to 20, wherein the processing unit U_{P} comprises a gas separation unit U_{PG}, wherein for ΔE≤0, the process stage (v″) comprises for x≠0
   (v″) passing the stream S_{R} or the stream S′_{R} into the gas separation unit U_{PG}, obtaining S_{H} and a CO-rich stream S_{CO};
   wherein the stream S_{CO} is preferably put to further use, wherein said further use preferably comprises the use of S_{CO} for the synthesis of methanol with hydrogen, preferably with hydrogen from renewable sources.
22. The method of any one of embodiment 16 to 20, wherein the processing unit U_{P} comprises a gas separation unit U_{PG} and a water gas shift reaction unit U_{PW}, wherein for ΔE≤0, the process stage (v″) comprises for x≠0
   (v″. 1) passing the stream S_{R} or the stream S′_{R} into the water gas shift reaction unit U_{PW}, obtaining a stream S_{W} comprising CO₂ and H₂;
   (v″0.2) passing the stream S_{W} into the gas separation unit U_{PG}, obtaining S_{H} and a CO₂-rich stream S_{CO2};
   wherein the stream S_{CO2} is preferably put to further use, wherein said further use preferably comprises one or more of carbon capture and storage (CCS) and carbon capture utilization (CCU).
23. The method of any one of embodiments 1 to 22, wherein from 60 to 100 volume-%, more preferably from 70 to 100 volume-%, more preferably from 80 to 100 volume-%, more preferably from 90 to 100 volume-%, more preferably from 95 to 100 volume-%, more preferably from 99 to 100 volume-% of the H₂-rich stream S_{H} consist of H₂.
24. The method of any one of embodiments 1 to 23, wherein for ΔE>0 and ΔH≤0, the process stage (vi′) comprises
   (vi′) passing the stream S_{H} obtained from U_{P} through M_{E}, obtaining a stream S′_{H} being y volume-% of S_{H}, with 0<y<100, and obtaining a stream S″_{H} being (100-y) volume-% of S_{H};
   wherein the stream S″_{H} or a part thereof is preferably put to further use, wherein said further use preferably comprises the use of S″_{H} as a heat source in one or more units other than U_{C}.
25. The method of any one of embodiments 1 to 24, wherein for ΔE≤0, the process stage (vii″) comprises, for x≠0, putting the stream S″_{H} or a part thereof to further use, wherein said further use preferably comprises the use of S″_{H} as a heat source in one or more units other than U_{C}.
26. The method of any one of embodiments 1 to 25, being at least partially computer-implemented.
27. The method of embodiment 26, wherein at least one of E_{UC}, E_{EXT-S} and ΔE is determined by a computer-supported control system, preferably wherein at least two of E_{UC}, E_{EXT-S} and ΔE are determined by a computer-supported control system, more preferably wherein all three of E_{UC}, E_{EXT-S} and ΔE are determined by a computer-supported control system.
28. The method of embodiment 26 or 27, wherein at least one M_{F}, U_{C}, M_{E}, U_{R}, U_{P} and M_{R} is determined by a computer-supported control system, preferably wherein at least two of M_{F}, U_{C}, M_{E}, U_{R}, U_{P} and M_{R} are determined by a computer-supported control system, more preferably wherein at least three of M_{F}, U_{C}, M_{E}, U_{R}, U_{P} and M_{R} are determined by a computer-supported control system, more preferably wherein at least four of M_{F}, U_{C}, M_{E}, U_{R}, U_{P} and M_{R} are determined by a computer-supported control system, more preferably wherein at least five of M_{F}, U_{C}, M_{E}, U_{R}, U_{P} and M_{R} are determined by a computer-supported control system, more preferably wherein all of M_{F}, U_{C}, M_{E}, U_{R}, U_{P} and M_{R} are determined by a computer-supported control system.
29. An integrated production plant, comprising
   (1) supply means M_{F} for providing one or more hydrocarbon feed streams S_{F} to a unit U_{C} for heat-consuming hydrocarbon conversion, wherein the supply means M_{F} are connected to U_{C} for passing at least one of said hydrocarbon feed stream S_{F} into U_{C} to obtain from U_{C} one or more product streams S and a light hydrocarbon conversion off-gas stream S_{O} comprising CH₄;
   (2) the unit U_{C} which comprises heating means M_{H} for providing heat to the hydrocarbon conversion, wherein said heating means M_{H} comprise means for generating heat from one or more heat sources H_{S} and wherein said one or more heat sources H_{S} comprise H₂;
   (3) controllable supply means M_{E} for providing one or more plant-external sustainable heat sources H_{EXT-S}, one or more plant-external fossil heat sources H_{EXT-F}, and one or more plant-internal heat sources H_{INT}, said plant-internal heat sources H_{INT} comprising H₂, wherein the supply means M_{E} are connected to U_{C} for passing at least one of said heat sources H_{EXT-S}, H_{EXT-F} and H_{INT} to the heating means M_{H};
   (4) a reforming unit U_{R} for subjecting the light hydrocarbon conversion off-gas stream S_{O} to reforming to obtain a product gas stream S_{R} comprising CO and H₂, wherein U_{R} is arranged downstream of U_{C} and connected to U_{C} for passing S_{O} into U_{R};
   (5) a controllable processing unit U_{P} for processing S_{R} to produce a stream S_{H} being enriched in H₂ compared to S_{R}, wherein U_{P} is arranged downstream of U_{R} and connected to U_{R} for passing S_{R} into U_{P};
   (6) and optionally controllable supply means M_{R} for optionally dividing the stream S_{R} into the part stream S′_{R} and a stream S″_{R}, wherein M_{R} is arranged downstream of U_{R} and upstream of U_{P}, connected to U_{R} for passing S_{R} into M_{R} and connected to U_{P} for passing S′_{R} or S″_{R} into U_{P}.
30. The integrated production plant of embodiment 29, wherein the unit U_{C} for heat-consuming hydrocarbon conversion comprises a cracking unit U_{CC}, preferably a thermal cracking unit, more preferably a steam cracking unit.
31. The integrated production plant of embodiment 30, wherein U_{C} further comprises a separation unit U_{S} for treating a cracked gas stream S_{C}, wherein U_{S} comprises at least one demethanizing unit, wherein from said demethanizing unit the stream S_{O} is obtained and wherein from U_{S}, the one or more product streams are obtained.
32. The integrated production plant of any one of embodiments 29 to 31, wherein the reforming unit U_{R} comprises one or more of an autothermal reforming (ATR) unit, a steam reforming (STR) unit, and a partial oxidation (POX) unit, preferably one or more of an autothermal reforming (ATR) unit and a steam reforming (STR) unit.
33. The integrated production plant of any one of embodiments 29 to 32, wherein the unit U_{P} comprises a gas separation unit U_{PG} for obtaining, from S_{R} or S′_{R}, the stream S_{H} and a CO-rich stream S_{CO}.
34. The integrated production plant of any one of embodiments 29 to 33, wherein the unit U_{P} comprises a water gas shift reaction unit U_{PW} for obtaining, from S_{R} or S′_{R}, a stream S_{W} comprising CO₂ and H₂, and further comprises, arranged downstream of U_{PW}, a gas separation unit U_{PG} for obtaining, from S_{W}, the stream S_{H} and a CO₂-rich stream S_{CO2}.
35. The integrated production plant of any one of embodiments 29 to 34, further comprising a computer-supported control system for controlling at least one of M_{F}, U_{C}, M_{H}, M_{E}, U_{R}, U_{P}, M_{R}, U_{CC}. U_{PG}, and U_{PW}.
36. A computer program comprising instructions which, when the program is executed by the computer-supported control system as defined in embodiment 35, cause the system to perform the method of any one of embodiments 1 to 28.
37. A non-transient computer-readable medium containing instructions which, when executed by one or more processors, cause the one or more processors to perform the program according to embodiment 36.
38. Use of the integrated production plant according to any one of embodiments 29 to 35 for carrying out the method according to any one of embodiments 1 to 28.
39. A method of using the integrated production plant according to any one of embodiments 29 to 35 for carrying out the method according to any one of embodiments 1 to 28.
40. A process for carrying out a heat-consuming hydrocarbon conversion in an integrated production plant which comprises
   (1) supply means M_{F} for providing one or more hydrocarbon feed streams S_{F} to a unit U_{C} for heat-consuming hydrocarbon conversion to obtain from U_{C} one or more product streams S and a light hydrocarbon conversion off-gas stream S_{O} comprising CH₄;
   (2) the unit U_{C} which comprises heating means M_{H} for providing heat to the hydrocarbon conversion, wherein said heating means M_{H} comprise means for generating heat from one or more heat sources H_{S} and wherein said one or more heat sources H_{S} comprise H₂;
   (3) controllable supply means M_{E} for providing one or more plant-external sustainable heat sources H_{EXT-S}, one or more plant-external fossil heat sources H_{EXT-F}, and one or more plant-internal heat sources H_{INT}, said plant-internal heat sources H_{INT} comprising H₂, for passing at least one of said heat sources H_{EXT-S}, H_{EXT-F} and H_{INT} to the heating means M_{H};
   (4) a reforming unit U_{R} for subjecting the light hydrocarbon conversion off-gas stream S_{O} to reforming to obtain a product gas stream S_{R} comprising CO and H₂;
   (5) a controllable processing unit U_{P} for processing S_{R} or a part stream S′_{R} thereof to obtain a stream S_{H} being enriched in H₂ compared to S_{R} or S′_{R};
   (6) and optionally comprises controllable supply means M_{R} for optionally dividing the stream S_{R} into the part stream S′_{R} and a stream S″_{R}, and for passing S′_{R} into U_{P};
   wherein the process comprises
   (i) passing one or more heat sources according to (3) from M_{E} to M_{H} in an amount sufficient for generating heat in My meeting the heat demand E_{UC} of U_{C};
   (ii) passing at least one hydrocarbon feed stream S_{F} into U_{C} and subjecting the at least one feed stream S_{F} to hydrocarbon conversion in U_{C}, obtaining the one or more product streams S and S_{O};
   (iii) passing S_{O} into U_{R} and subjecting S_{O} to reforming in U_{R}, obtaining S_{R};
   wherein during the process, parameters E_{UC}, E_{EXT-S}, ΔΕ, H_{2N}, H_{2P} and ΔH as defined in any one of embodiments 1 to 25 are determined,
   wherein for ΔE>0 and ΔH>0, the process further comprises
   (iv) optionally passing S_{R} obtained from U_{R} through M_{R}, obtaining a stream S′_{R} being x volume-% of S_{R}, with x=100;
   (v) passing the stream S_{R} or, if (iv) is carried out, the stream S′_{R} into U_{P}, obtaining S_{H};
   (vi) passing the stream S_{H} obtained from U_{P} through M_{E}, obtaining a stream S′_{H} being y volume-% of S_{H}, with y=100;
   (vii) passing the stream S′_{H} obtained from M_{E} as H_{INT} into M_{H};
   (viii) passing at least one of the one or more plant-external fossil heat sources H_{EXT-F} via M_{E} into M_{H} in an amount sufficient to generate heat in an amount (ΔE−E_{H2P}) in M_{H};
   wherein for ΔE>0 and ΔH≤0, the process further comprises
   (iv′) optionally passing S_{R} obtained from U_{R} through M_{R}, obtaining a stream S′_{R} being x volume-% of S_{R}, with 0<x≤100;
   (v′) passing the stream S_{R} or, if (iv) is carried out, the stream S′_{R} into U_{P}, obtaining S_{H};
   (vi′) passing the stream S_{H} obtained from U_{P} through M_{E}, obtaining a stream S′_{H} being y volume-% of S_{H}, with 0<y≤100;
   (vii′) passing the stream S′_{H} obtained from M_{E} as H_{INT} into M_{H};
   wherein for ΔE≤0, the process further comprises
   (iv″) optionally passing S_{R} obtained from U_{R} through M_{R}, obtaining a stream S′_{R} being x volume-% of S_{R}, with 0≤x≤100;
   (v″) passing the stream S_{R} or, if (iv′) is carried out and x≠0, the stream S′_{R} into U_{P}, obtaining S_{H};
   (vi″) passing the stream S_{H}, if obtained from U_{P}, through M_{E}, obtaining a stream S″_{H} being 100 volume-% of S_{H};
   (vii″) removing the stream S″_{H} from M_{E}.
41. The process of embodiment 40, wherein U_{C} further comprises a separation unit U_{S},
   wherein according to (ii), the process comprises
   (ii.1) passing at least one hydrocarbon feed stream S_{F} into U_{C} and subjecting the at least one feed stream S_{F} to hydrocarbon conversion in U_{C}, obtaining a cracked gas stream S_{C};
   (ii.2) passing the cracked gas stream S_{C} obtained according to (ii.1) to a separation unit U_{S} comprising at least one demethanizing unit, obtaining from said demethanizing unit the stream S_{O}, wherein from U_{S}, the one or more product streams S are obtained.
42. The process of embodiment 40 or 41,
   wherein (iv) comprises
   (iv) passing S_{R} obtained from U_{R} through M_{R}, obtaining a stream S′_{R} being x volume-% of S_{R}, with x=100;
   wherein (iv′) comprises
   (iv′) passing S_{R} obtained from U_{R} through M_{R}, obtaining a stream S′_{R} being x volume-% of S_{R}, with 0≤x<100, and obtaining a stream S″_{R} being (100-x) volume-% of S_{R};
   wherein (iv″) comprises
   (iv″) passing S_{R} obtained from U_{R} through M_{R}, obtaining a stream S′_{R} being x volume-% of S_{R}, with 0≤x<100, and obtaining a stream S″_{R} being (100-x) volume-% of S_{R}.
43. The process of any one of embodiments 40 to 42, wherein the processing unit U_{P} comprises a gas separation unit U_{PG},
   wherein (v) comprises
   (v) passing the stream S_{R} or the stream S′_{R} into the gas separation unit U_{PG}, obtaining S_{H} and a CO-rich stream S_{CO};
   wherein (v′) comprises
   (v′) passing the stream S_{R} or the stream S′_{R} into the gas separation unit U_{PG}, obtaining S_{H} and a CO-rich stream S_{CO};
   wherein (v″) comprises
   (v″) passing the stream S_{R} or the stream S′_{R} into the gas separation unit U_{PG}, obtaining S_{H} and a CO-rich stream S_{CO}.
44. The process of any one of embodiments 40 to 43, wherein the processing unit U_{P} comprises a gas separation unit U_{PG} and a water gas shift reaction unit U_{PW},
   wherein (v) comprises
   (v.1) passing the stream S_{R} or the stream S′_{R} into the water gas shift reaction unit U_{PW}, obtaining a stream S_{W} comprising CO₂ and H₂;
   (v.2) passing the stream S_{W} into the gas separation unit U_{PG}, obtaining S_{H} and a CO₂-rich stream S_{CO2};
   wherein (v′) comprises
   (v′. 1) passing the stream S_{R} or the stream S′_{R} into the water gas shift reaction unit U_{PW}, obtaining a stream S_{W} comprising CO₂ and H₂;
   (v′0.2) passing the stream S_{W} into the gas separation unit U_{PG}, obtaining S_{H} and a CO₂-rich stream S_{CO2};
   wherein (v″) comprises
   (v″. 1) passing the stream S_{R} or the stream S′_{R} into the water gas shift reaction unit U_{PW}, obtaining a stream S_{W} comprising CO₂ and H₂;
   (v″0.2) passing the stream S_{W} into the gas separation unit U_{PG}, obtaining S_{H} and a CO₂-rich stream S_{CO2}.
45. The process of any one of embodiments 40 to 44,
   wherein (vi′) comprises
   (vi′) passing the stream S_{H} obtained from U_{P} through M_{E}, obtaining a stream S′_{H} being y volume-% of S_{H}, with 0<y<100, and obtaining a stream S″_{H} being (100-y) volume-% of S_{H}.
46. The method of any one of embodiments 40 to 45, being at least partially computer-implemented.

### DESCRIPTION OF THE FIGURES

FIG. 1 is a schematic representation of interconnected units and means of an integrated production plant of the present invention and used for carrying out the method of the present invention, and of streams passed into and obtained from said units and means. In this figure, supply means M_{F} are shown for for providing one or more hydrocarbon feed streams S_{F} to a unit U_{C} for heat-consuming hydrocarbon conversion. In this unit U_{C}, the hydrocarbon conversion take place, and from U_{C}, the one or more product streams S and the light hydrocarbon conversion off-gas stream S_{O} comprising CH₄ are obtained. Further, the unit U_{C} comprises heating means My which in turn comprise means for generating heat from one or more heat sources H_{S} (plant-external sustainable heat sources H_{EXT-S} plant-external fossil heat sources H_{EXT-S}, and plant-internal heat sources H_{INT}) wherein said one or more heat sources H_{S} comprise hydrogen (H₂). The light hydrocarbon conversion off-gas stream S_{O} comprising CH₄ is then passed to the reforming unit U_{R} from which the stream S_{R} is obtained which comprises H₂ and CO. This stream S_{R} is then passed into the processing unit U_{P} from which the H₂-rich stream S_{H} (and optionally one or more other streams, indicated by the dotted arrow) is obtained.

If, according to the control method of the present invention, the determined value ΔE=E_{UC}−E_{EXT-S}, i.e. the difference of the heat demand of U_{C} and the heat which can be supplied to U_{C} via the one or more plant-external sustainable heat sources H_{EXT-S}, indicated by the dotted arrow labelled “ext”, is greater than zero, i.e. the heat demand of U_{C} cannot be met solely by the plant-external sustainable heat sources, the following parameters are determined:
the amount of H₂ which is necessary to produce ΔE in the means M_{H}. This amount is referred to herein as H_{2N}.
the maximum amount of H₂ which can be produced in U_{R} and U_{P}, which maximum amount of H₂ is then contained in the stream S_{H}. This amount is referred to herein as H_{2P} and based on H_{2P}, an amount of heat can be produced which amount is referred to herein as E_{H2P}.
the parameter ΔH which is defined as the difference H_{2N}−H_{2P}.

If ΔH is greater than zero, which means that the heat demand ΔE cannot be covered by the maximum amount H_{2P} alone, the processing unit U_{P}, the supply means M_{E} are controlled so that the maximum amount H_{2P} is passed via into My via the H₂-rich stream S_{H} and S′_{H} so as to produce E_{H2P} in M_{H}. As far as the remaining amount of heat is concerned in this case, at least one of the plant-external fossil heat sources H_{EXT-F} is passed via M_{E} into My in an amount which is sufficient to generate said remaining amount of heat (ΔE−E_{H2P}).

If ΔH is less than or equal to zero, which means that the heat demand ΔE can be covered by the amount of H₂ which is available via U_{R} and U_{P}, the processing unit U_{P}, the supply means M_{E} are controlled so that an amount of H₂ is passed into My via the H₂-rich stream S_{H} and S′_{H} which is sufficient to produce said amount of ΔE in M_{H}. For this situation, it is possible to control U_{P} in such a manner that the amount of H₂ in S_{H} is sufficient for producing said amount of ΔE in M_{H}; in this case, the stream S_{H} would be identical to the stream S′_{H}, i.e. the supply means M_{E} are controlled in such a manner that the entire stream S_{H} is passed as the stream S′_{H} into M_{H}. If, however, the amount of H₂ available via S_{H} would be too high, i.e. the heat produced in M_{H} based on S_{H}=S′_{H} would be too high, e.g. due to the fact that the control of U_{P} would not allow for producing a lower amount of S_{H}, the supply means M_{E} can be controlled in a manner so that only a suitable part of S_{H}, namely S′_{H}, sufficient for producing ΔE, is passed into M_{H} and a part of S_{H}, S″_{H}, is put to one or more further suitable uses.

If, according to the control method of the present invention, the determined value ΔE=E_{UC}−E_{EXT-S}, i.e. the difference of the heat demand of U_{C} and the heat which can be supplied to U_{C} via the one or more plant-external sustainable heat sources H_{EXT-S}, is less than or equal to zero, i.e. the heat demand of U_{C} can be met solely by the plant-external sustainable heat sources H_{EXT-S}, the processing unit U_{P}, the supply means M_{E} are controlled in such a manner that no H₂ is passed into M_{H} via the H₂-rich stream S_{H}. In this case, the supply means M_{E} are controlled in a manner so that no part of S_{H} is passed into M_{H} and S″_{H}, which is identical to S_{H}, is put to one or more further suitable uses.

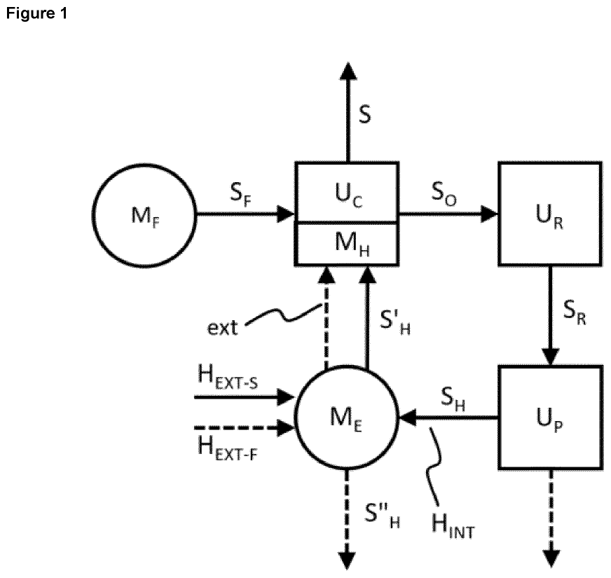

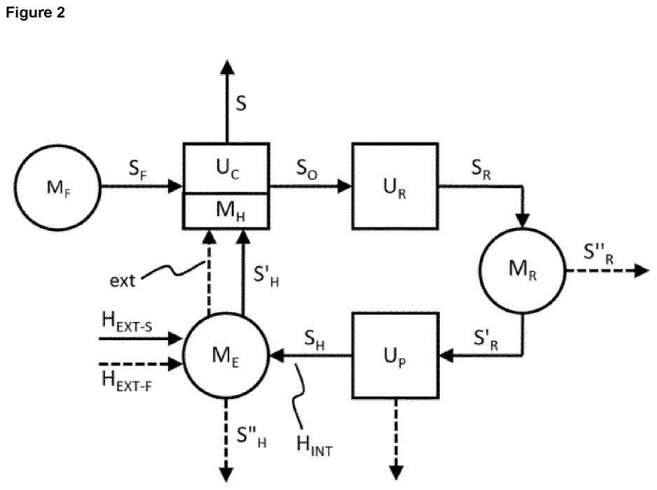

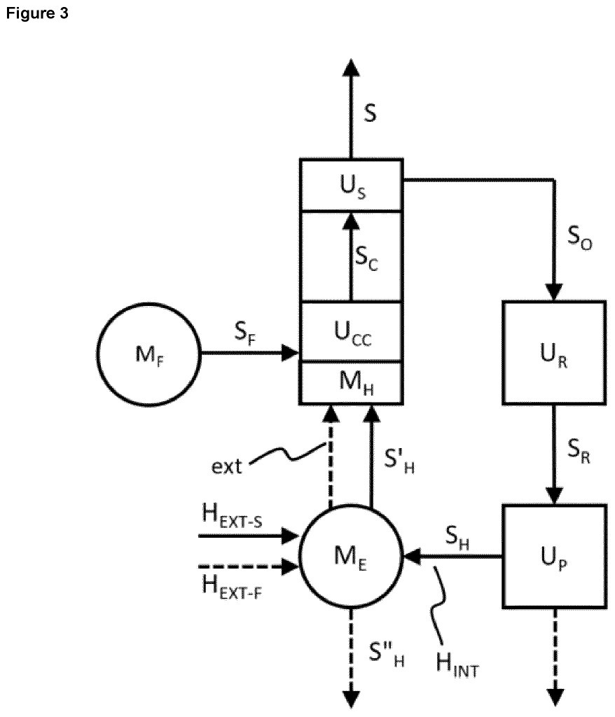

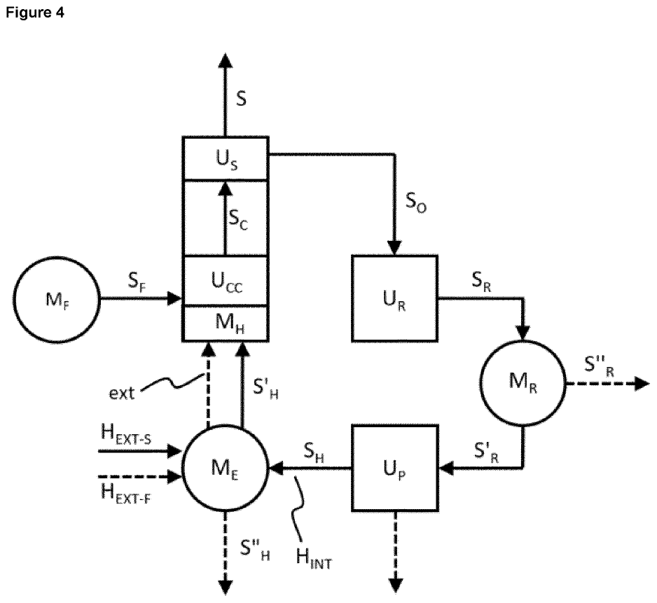

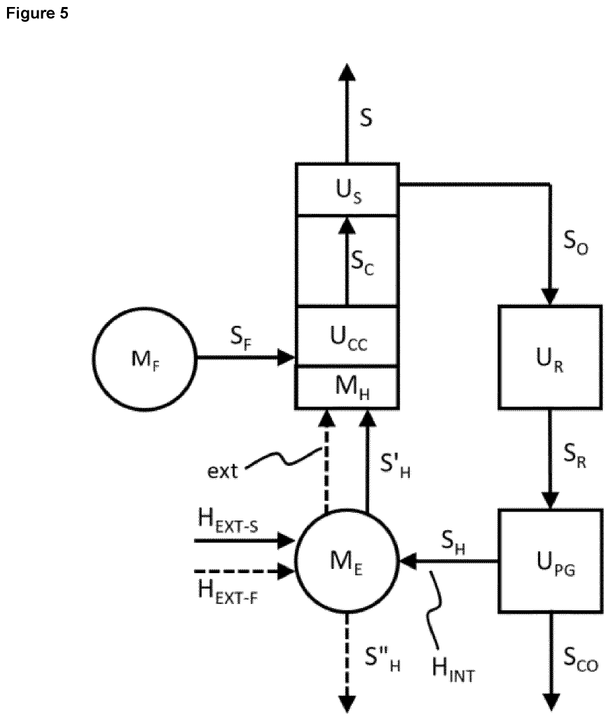

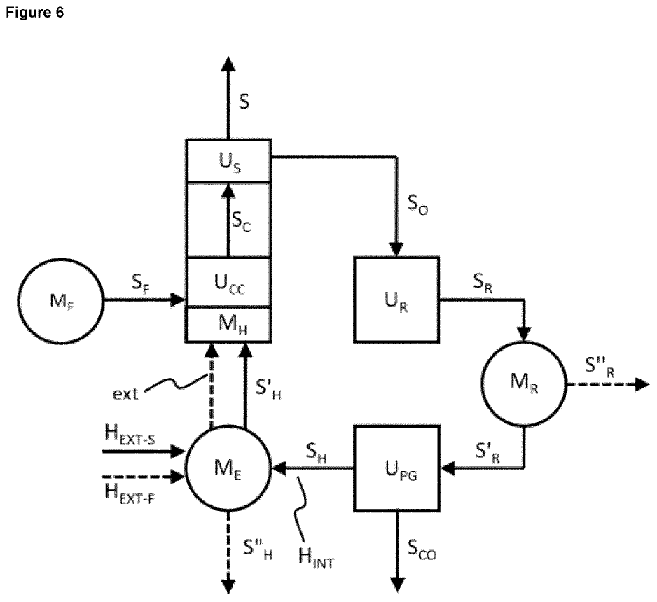

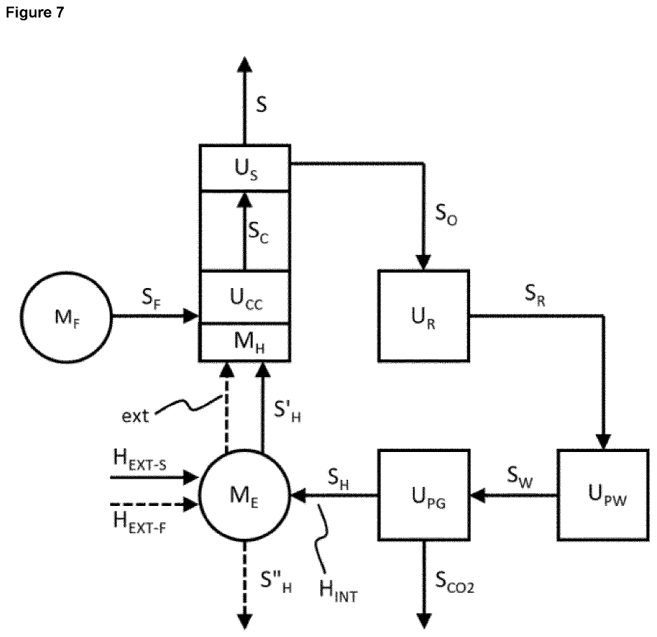

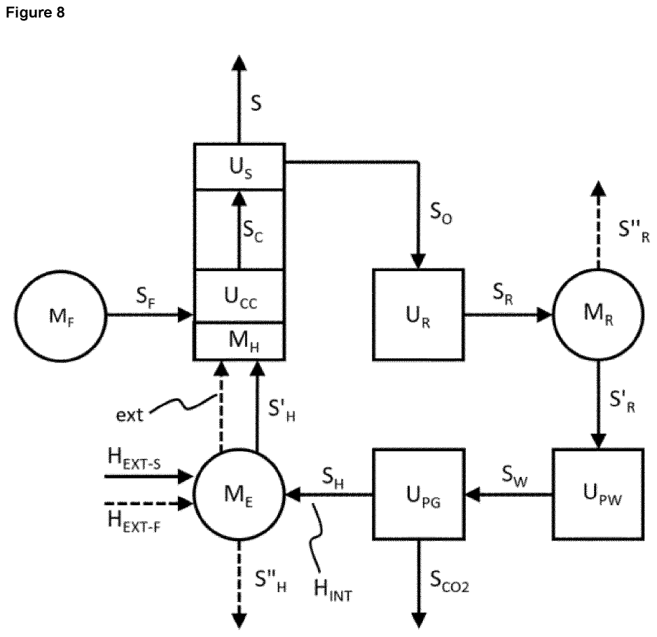

FIG. 2 is a schematic representation of interconnected units and means of an integrated production plant of the present invention used for carrying out the method of the present invention, and of streams passed into and obtained from said units and means. Compared with FIG. 1, the plant comprises additional controllable supply means M_{R} arranged downstream of U_{R} and upstream of U_{P}. By integrating M_{R} into the plant, there is an additional possibility to control the overall process. In particular, M_{R} allow for dividing the stream S_{R} obtained from reforming and passing a respective part stream S′_{R} to U_{P} which can then be dealt with as described above for FIG. 1. The respectively obtained part stream S″_{R} can be put to further use wherein it is preferred to use it as a synthesis gas, in particular for producing one or more of methanol, a liquid fuel, a hydrocarbon, a lubricant, an oxoalcohol and ammonia. Further, depending on e.g. the energy demand of U_{C}, it is possible according to the invention that the entire stream S_{R} is passed through M_{R} wherein in this scenario, S′_{R} is identical to S_{R}.

FIG. 3 is a schematic representation of interconnected units and means of an integrated production plant of the present invention used for carrying out the method of the present invention, and of streams passed into and obtained from said units and means. Compared to FIG. 1, a preferred configuration of the unit U_{C} is shown, wherein U_{C} comprises a cracking unit U_{CC}, preferably a thermal cracking unit, more preferably a steam cracking unit. Further, the unit U_{C} comprises a separation unit U_{S} which is used for a downstream treatment of the cracked gas stream S_{C} obtained from U_{CC}. This separation unit U_{S} comprises a demethanizing stage (not shown) from which the light hydrocarbon conversion off-gas stream S_{O} is obtained.

FIG. 4 is a schematic representation of interconnected units and means of an integrated production plant of the present invention used for carrying out the method of the present invention, and of streams passed into and obtained from said units and means. Compared to FIG. 3, the plant shown here additionally comprises the means M_{R} described in detail in the context of FIG. 2 above.

FIG. 5 is a schematic representation of interconnected units and means of an integrated production plant of the present invention used for carrying out the method of the present invention, and of streams passed into and obtained from said units and means. Compared to FIG. 3, a specific configuration of the unit U_{P} is shown, namely the configuration as a gas separation unit U_{PG} which serves for separating a H₂-rich gas stream S_{H} from the reforming stream S_{R}, wherein in addition to S_{H}, a CO-rich stream S_{CO} is obtained.

FIG. 6 is a schematic representation of interconnected units and means of an integrated production plant of the present invention and used for carrying out the method of the present invention, and of streams passed into and obtained from said units and means. Compared to FIG. 5, the plant shown here additionally comprises the means M_{R} described in detail in the context of FIG. 2 above.

FIG. 7 is a schematic representation of interconnected units and means of an integrated production plant of the present invention used for carrying out the method of the present invention, and of streams passed into and obtained from said units and means. Compared to FIG. 5, another specific configuration of the unit U_{P} is shown, namely the configuration as a water gas shift reaction unit U_{PW} with a downstream gas separation unit U_{PG}. In the unit U_{GW}, the stream S_{R} is subjected to water gas shift reaction, and a stream S_{W} is obtained which comprises CO₂ and H₂, and which is then passed to U_{PG}. In this case, the gas separation unit U_{GS} serves for separating a H₂-rich gas stream S_{H} from the stream S_{W}, wherein in addition to S_{H}, a CO₂-rich stream S_{CO2} is obtained.

FIG. 8 is a schematic representation of interconnected units and means of an integrated production plant of the present invention used for carrying out the method of the present invention, and of streams passed into and obtained from said units and means. Compared to FIG. 7, the plant shown here additionally comprises the means M_{R} described in detail in the context of FIG. 2 above.

1.-17. (canceled)

18. A method for controlling a process carried out in an integrated production plant, wherein the integrated production plant comprises:
(1) supply means M_{F} for providing one or more hydrocarbon feed streams S_{F} to a unit U_{C} for heat-consuming hydrocarbon conversion to obtain from U_{C} one or more product streams S and a light hydrocarbon conversion off-gas stream S_{O} comprising CH₄;
(2) the unit U_{C} which comprises heating means M_{H} for providing heat to the hydrocarbon conversion, wherein said heating means M_{H} comprise means for generating heat from one or more heat sources H_{S} and wherein said one or more heat sources H_{S} comprise H₂;
(3) controllable supply means M_{E} for providing one or more plant-external sustainable heat sources H_{EXT-S}, one or more plant-external fossil heat sources H_{EXT-F}, and one or more plant-internal heat sources H_{INT}, said plant-internal heat sources H_{INT} comprising H₂, for passing at least one of said heat sources H_{EXT-S}, H_{EXT-F} and H_{INT} to the heating means M_{H};
(4) a reforming unit U_{R} for subjecting the light hydrocarbon conversion off-gas stream S_{O} to reforming to obtain a product gas stream S_{R} comprising CO and H₂;
(5) a controllable processing unit U_{P} for processing S_{R} or a part stream S′_{R} thereof to obtain a stream S_{H} being enriched in H₂ compared to S_{R} or S′_{R}; and
(6) and optionally comprises controllable supply means M_{R} for optionally dividing the stream S_{R} into the part stream S′_{R} and a stream S″_{R}, and for passing S′_{R} into U_{P};
wherein the process comprises:
(i) passing one or more heat sources according to (3) from M_{E} to M_{H} in an amount sufficient for generating heat in M_{H} meeting the heat demand E_{UC} of the hydrocarbon conversion in U_{C};
(ii) passing at least one hydrocarbon feed stream S_{F} into U_{C} and subjecting the at least one feed stream S_{F} to hydrocarbon conversion in U_{C}, obtaining the one or more product streams S and S_{O}; and
(iii) passing S_{O} into U_{R} and subjecting S_{O} to reforming in U_{R}, obtaining S_{R};
wherein the method for controlling the process comprises:
(a) determining the heat demand E_{UC} of the hydrocarbon conversion in U_{C} to be provided by M_{H};
(b) determining the amount E_{EXT-S} of heat available for U_{C} from the one or more plant-external sustainable heat sources H_{EXT-S}; and
(c) determining ΔE=E_{UC}−E_{EXT-S} and
(c.1) if ΔE>0,
(c.1.1) determining H_{2N}, the amount of H₂ necessary to produce ΔE in M_{H};
(c.1.2) determining H_{2P}, the maximum amount of H₂, producible in U_{R} and U_{P} to be contained in S_{H}, to produce an amount E_{H2P} of heat in M_{H};
(c.1.3) determining ΔH=H_{2N}−H_{2P}; and
(c.1.3.1) if ΔH>0,
controlling the processing unit U_{P}, the supply means M_{E} and optionally the supply means M_{R} so that H_{2P} is passed into M_{H} via S_{H};
wherein the process further comprises:
(iv) optionally passing S_{R} obtained from U_{R} through M_{R}, obtaining a stream S′_{R} being x volume-% of S_{R}, with x=100;
(v) passing the stream S_{R} or, if (iv) is carried out, the stream S′_{R} into U_{P}, obtaining S_{H};
(vi) passing the stream S_{H} obtained from U_{P} through M_{E}, obtaining a stream S′_{H} being y volume-% of S_{H}, with y=100;
(vii) passing the stream S′_{H} obtained from M_{E} as H_{INT} into M_{H}; and
(viii) passing at least one of the one or more plant-external fossil heat sources H_{EXT-F} via M_{E} into M_{H} in an amount sufficient to generate heat in an amount (ΔE−E_{H2P}) in M_{H};
(c.1.3.2) if ΔH≤0,
controlling the processing unit U_{P}, the supply means M_{E} and optionally the supply means M_{R} so that an amount of H₂ is passed into M_{H} via S_{H} which is sufficient to produce ΔE in M_{H};
wherein the process further comprises:
(iv′) optionally passing S_{R} obtained from U_{R} through M_{R}, obtaining a stream S′_{R} being x volume-% of S_{R}, with 0<x≤100;
(v′) passing the stream S_{R} or, if (iv) is carried out, the stream S′_{R} into U_{P}, obtaining S_{H};
(vi′) passing the stream S_{H} obtained from U_{P} through M_{E}, obtaining a stream S′_{H} being y volume-% of S_{H}, with 0<y≤100; and
(vii′) passing the stream S′_{H} obtained from M_{E} as H_{INT} into M_{H}; and
(c.2) if ΔE≤0,
controlling the processing unit U_{P}, the supply means M_{E} and optionally the supply means M_{R} so that no H₂ is passed into M_{H} via S_{H};
wherein the process further comprises:
(iv″) optionally passing S_{R} obtained from U_{R} through M_{R}, obtaining a stream S′_{R} being x volume-% of S_{R}, with 0≤x≤100;
(v″) passing the stream S_{R} or, if (iv′) is carried out and x≠0, the stream S′_{R} into U_{P}, obtaining S_{H};
(vi″) passing the stream S_{H}, if obtained from U_{P}, through M_{E}, obtaining a stream S″_{H} being 100 volume-% of S_{H}; and
(vii″) removing the stream S″_{H} from M_{E}.

19. The method of claim 18, wherein from 40 to 100 volume-% of S_{O} consist of CH₄.

20. The method of claim 18, wherein the unit U_{C} for heat-consuming hydrocarbon conversion comprises a cracking unit U_{CC}.

21. The method of claim 20, wherein U_{C} further comprises a separation unit U_{S}, wherein according to (ii), the process comprises
(ii.1) passing at least one hydrocarbon feed stream S_{F} into U_{C} and subjecting the at least one feed stream S_{F} to hydrocarbon conversion in U_{C}, obtaining a cracked gas stream S_{C};
(ii.2) passing the cracked gas stream S_{C} obtained according to (ii.1) to a separation unit Us comprising at least one demethanizing unit, obtaining from said demethanizing unit the stream S_{O}, wherein from U_{S}, the one or more product streams S are obtained.

22. The method of claim 18, wherein from 96 to 100 volume-% of S_{O} consists of CH₄.

23. The method of claim 18, wherein the one or more plant-external sustainable heat sources H_{EXT-S} according to (3) comprise one or more of solar energy, wind energy, hydro energy, tidal energy, geothermal energy, and biomass energy, ammonia obtained from renewable sources, biomethane, bio-LNG and H₂ obtained from renewable sources.

24. The method of claim 18, wherein the reforming unit U_{R} according to (4) comprises one or more of an autothermal reforming (ATR) unit, a steam reforming (STR) unit, and a partial oxidation (POX) unit.

25. The method of claim 18,
wherein (iv) comprises
(iv) passing S_{R} obtained from U_{R} through M_{R}, obtaining a stream S′_{R} being x volume-% of S_{R}, with x=100;
wherein (iv′) comprises
(iv′) passing S_{R} obtained from U_{R} through M_{R}, obtaining a stream S′_{R} being x volume-% of S_{R}, with 0<x<100, and obtaining a stream S″_{R} being (100-x) volume-% of S_{R};
wherein (iv″) comprises
(iv″) passing S_{R} obtained from U_{R} through M_{R}, obtaining a stream S′_{R} being x volume-% of S_{R}, with 0≤x<100, and obtaining a stream S″_{R} being (100-x) volume-% of S_{R};
wherein at least a part of the stream S″_{R} is put to the use of S″_{R} as synthesis gas.

26. The method of claim 18, wherein the processing unit U_{P} according to (5) comprises one or more of a gas separation unit U_{PG} and a water gas shift reaction unit U_{PW}.

27. The method of claim 26, wherein the processing unit U_{P} comprises a gas separation unit U_{PG},
wherein (v) comprises
(v) passing the stream S_{R} or the stream S′_{R} into the gas separation unit U_{PG}, obtaining S_{H} and a CO-rich stream S_{CO};
wherein (v′) comprises
(v′) passing the stream S_{R} or the stream S′_{R} into the gas separation unit U_{PG}, obtaining S_{H} and a CO-rich stream S_{CO};
wherein (v″) comprises
(v″) passing the stream S_{R} or the stream S′_{R} into the gas separation unit U_{PG}, obtaining S_{H} and a CO-rich stream S_{CO};
wherein the stream S_{CO} is put to the use of S_{CO} for the synthesis of methanol with hydrogen.

28. The method of claim 26, wherein the processing unit U_{P} comprises a gas separation unit U_{PG} and a water gas shift reaction unit U_{PW},
wherein (v) comprises:
(v.1) passing the stream S_{R} or the stream S′_{R} into the water gas shift reaction unit U_{PW}, obtaining a stream S_{W} comprising CO₂ and H₂; and
(v.2) passing the stream S_{W} into the gas separation unit U_{PG}, obtaining S_{H} and a CO₂-rich stream S_{CO2};
wherein (v′) comprises:
(v′0.1) passing the stream S_{R} or the stream S′_{R} into the water gas shift reaction unit U_{PW}, obtaining a stream S_{W} comprising CO₂ and H₂; and
(v′0.2) passing the stream S_{W} into the gas separation unit U_{PG}, obtaining S_{H} and a CO₂-rich stream S_{CO2};
wherein (v″) comprises:
(v″0.1) passing the stream S_{R} or the stream S′_{R} into the water gas shift reaction unit U_{PW}, obtaining a stream S_{W} comprising CO₂ and H₂; and
(v″0.2) passing the stream S_{W} into the gas separation unit U_{PG}, obtaining S_{H} and a CO₂-rich stream S_{CO2};
wherein the stream S_{CO2} is put to one or more of carbon capture and storage (CCS) and carbon capture utilization (CCU).

29. The method of claim 18, wherein from 60 to 100 volume-% of the H₂-rich stream S_{H} consist of H₂.

30. The method of claim 18, wherein (vi′) comprises:
(vi′) passing the stream S_{H} obtained from U_{P} through M_{E}, obtaining a stream S′_{H} being y volume-% of S_{H}, with 0<y<100, and obtaining a stream S″_{H} being (100-y) volume-% of S_{H},
wherein the stream S″_{H} or a part thereof is put to the use of S″_{H} as a heat source in one or more units other than U_{C}.

31. The method of claim 18, wherein (vii″) comprises, for x≠0, putting the stream S″_{H} or a part thereof to further use, wherein said further use comprises the use of S″_{H} as a heat source in one or more units other than U_{C}.

32. An integrated production plant for carrying out the method according to claim 18, comprising:
(1) supply means M_{F} for providing one or more hydrocarbon feed streams S_{F} to a unit U_{C} for heat-consuming hydrocarbon conversion, wherein the supply means M_{F} are connected to U_{C} for passing at least one of said hydrocarbon feed stream S_{F} into U_{C} to obtain from U_{C} one or more product streams S and a light hydrocarbon conversion off-gas stream S_{O} comprising CH₄;
(2) the unit U_{C} which comprises heating means M_{H} for providing heat to the hydrocarbon conversion, wherein said heating means M_{H} comprise means for generating heat from one or more heat sources H_{S} and wherein said one or more heat sources H_{S} comprise H₂;
(3) controllable supply means M_{E} for providing one or more plant-external sustainable heat sources H_{EXT-S}, one or more plant-external fossil heat sources H_{EXT-F}, and one or more plant-internal heat sources H_{INT}, said plant-internal heat sources H_{INT} comprising H₂, wherein the supply means M_{E} are connected to U_{C} for passing at least one of said heat sources H_{EXT-S}, H_{EXT-F} and H_{INT} to the heating means M_{H};
(4) a reforming unit U_{R} for subjecting the light hydrocarbon conversion off-gas stream S_{O} to reforming to obtain a product gas stream S_{R} comprising CO and H₂, wherein U_{R} is arranged downstream of U_{C} and connected to U_{C} for passing S_{O} into U_{R};
(5) a controllable processing unit U_{P} for processing S_{R} to produce a stream S_{H} being enriched in H₂ compared to S_{R}, wherein U_{P} is arranged downstream of U_{R} and connected to U_{R} for passing S_{R} into U_{P}; and
(6) and optionally comprises controllable supply means M_{R} for optionally dividing the stream S_{R} into the part stream S′_{R} and a stream S″_{R}, wherein M_{R} is arranged downstream of U_{R} and upstream of U_{P}, connected to U_{R} for passing S_{R} into M_{R} and connected to U_{P} for passing S′_{R} or S″_{R} into U_{P};
wherein the unit U_{C} for heat-consuming hydrocarbon conversion comprises a cracking unit U_{CC}, wherein U_{C} further comprises a separation unit U_{S} for treating a cracked gas stream S_{C}, wherein U_{S} comprises at least one demethanizing unit, wherein from said demethanizing unit the stream S_{O} is obtained and wherein from U_{S}, the one or more product streams are obtained;
wherein the reforming unit U_{R} comprises one or more of an autothermal reforming (ATR) unit, a steam reforming (STR) unit, and a partial oxidation (POX) unit;
wherein the unit U_{P} comprises a gas separation unit U_{PG} for obtaining, from S_{R} or S′_{R}, the stream S_{H} and a CO-rich stream S_{CO}, or comprises a water gas shift reaction unit U_{PW} for obtaining, from S_{R} or S′_{R}, a stream S_{W} comprising CO₂ and H₂, and further comprises, arranged downstream of U_{PW}, a gas separation unit U_{PG} for obtaining, from S_{W}, the stream S_{H} and a CO₂-rich stream S_{CO2}.

33. The integrated production plant of claim 32, further comprising a computer-supported control system for controlling at least one of M_{E}, U_{C}, M_{H}, M_{E}, U_{R}, U_{P}, M_{R}, U_{CC}. U_{PG} and U_{PW}.

34. A computer program comprising instructions which, when the program is executed by the computer-supported control system as defined in claim 33, cause the system to perform the method for controlling a process carried out in an integrated production plant, wherein the integrated production plant comprises:
(7) supply means M_{F} for providing one or more hydrocarbon feed streams S_{F} to a unit U_{C} for heat-consuming hydrocarbon conversion to obtain from U_{C} one or more product streams S and a light hydrocarbon conversion off-gas stream S_{O} comprising CH₄;
(8) the unit U_{C} which comprises heating means M_{H} for providing heat to the hydrocarbon conversion, wherein said heating means M_{H} comprise means for generating heat from one or more heat sources H_{S} and wherein said one or more heat sources H_{S} comprise H₂;
(9) controllable supply means M_{E} for providing one or more plant-external sustainable heat sources H_{EXT-S}, one or more plant-external fossil heat sources H_{EXT-F}, and one or more plant-internal heat sources H_{INT}, said plant-internal heat sources H_{INT} comprising H₂, for passing at least one of said heat sources H_{EXT-S}, H_{EXT-F} and H_{INT} to the heating means M_{H};
(10) a reforming unit U_{R} for subjecting the light hydrocarbon conversion off-gas stream S_{O} to reforming to obtain a product gas stream S_{R} comprising CO and H₂;
(11) a controllable processing unit U_{P} for processing S_{R} or a part stream S′_{R} thereof to obtain a stream S_{H} being enriched in H₂ compared to S_{R} or S′_{R}; and
(12) and optionally comprises controllable supply means M_{R} for optionally dividing the stream S_{R} into the part stream S′_{R} and a stream S″_{R}, and for passing S′_{R} into U_{P};
wherein the process comprises:
(ix) passing one or more heat sources according to (3) from M_{E} to M_{H} in an amount sufficient for generating heat in M_{H} meeting the heat demand E_{UC} of the hydrocarbon conversion in U_{C};
(x) passing at least one hydrocarbon feed stream S_{F} into U_{C} and subjecting the at least one feed stream S_{F} to hydrocarbon conversion in U_{C}, obtaining the one or more product streams S and S_{O}; and
(xi) passing S_{O} into U_{R} and subjecting S_{O} to reforming in U_{R}, obtaining S_{R};
wherein the method for controlling the process comprises:
(d) determining the heat demand E_{UC} of the hydrocarbon conversion in U_{C} to be provided by M_{H};
(e) determining the amount E_{EXT-S} of heat available for U_{C} from the one or more plant-external sustainable heat sources H_{EXT-S}; and
(f) determining ΔE=E_{UC}−E_{EXT-S} and
(c.1) if ΔE>0,
(c.1.1) determining H_{2N}, the amount of H₂ necessary to produce ΔE in M_{H};
(c.1.2) determining H_{2P}, the maximum amount of H₂, producible in U_{R} and U_{P} to be contained in S_{H}, to produce an amount E_{H2P} of heat in M_{H};
(c.1.3) determining ΔH=H_{2N}—H_{2P}; and
(c.1.3.1) if ΔH>0,
controlling the processing unit U_{P}, the supply means M_{E} and optionally the supply means M_{R} so that H_{2P} is passed into M_{H} via S_{H};
wherein the process further comprises:
(xii) optionally passing S_{R} obtained from U_{R} through M_{R}, obtaining a stream S′_{R} being x volume-% of S_{R}, with x=100;
(xiii) passing the stream S_{R} or, if (iv) is carried out, the stream S′_{R} into U_{P}, obtaining S_{H};
(xiv) passing the stream S_{H} obtained from U_{P} through M_{E}, obtaining a stream S′_{H} being y volume-% of S_{H}, with y=100;
(xv) passing the stream S′_{H} obtained from M_{E} as H_{INT} into M_{H}; and
(xvi) passing at least one of the one or more plant-external fossil heat sources H_{EXT-F} via M_{E} into M_{H} in an amount sufficient to generate heat in an amount (ΔE−E_{H2P}) in M_{H};
(c.1.3.2) if ΔH≤0,
controlling the processing unit U_{P}, the supply means M_{E} and optionally the supply means M_{R} so that an amount of H₂ is passed into M_{H} via S_{H} which is sufficient to produce ΔE in M_{H};
wherein the process further comprises:
(iv′) optionally passing S_{R} obtained from U_{R} through M_{R}, obtaining a stream S′_{R} being x volume-% of S_{R}, with 0<x≤100;
(v′) passing the stream S_{R} or, if (iv) is carried out, the stream S′_{R} into U_{P}, obtaining S_{H};
(vi′) passing the stream S_{H} obtained from U_{P} through M_{E}, obtaining a stream S′_{H} being y volume-% of S_{H}, with 0<y≤100; and
(vii′) passing the stream S′_{H} obtained from M_{E} as H_{INT} into M_{H}; and
(c.2) if ΔE≤0,
controlling the processing unit U_{P}, the supply means M_{E} and optionally the supply means M_{R} so that no H₂ is passed into M_{H} via S_{H};
wherein the process further comprises:
(iv″) optionally passing S_{R} obtained from U_{R} through M_{R}, obtaining a stream S′_{R} being x volume-% of S_{R}, with 0≤x≤100;
(v″) passing the stream S_{R} or, if (iv′) is carried out and x≠0, the stream S′_{R} into U_{P}, obtaining S_{H};
(vi″) passing the stream S_{H}, if obtained from U_{P}, through M_{E}, obtaining a stream S″_{H} being 100 volume-% of S_{H}; and
(vii″) removing the stream S″_{H} from M_{E}.
